(19) United States
(12) Patent Application Publication
(10) Pub. No.: US 2008/0057438 A1
(43) Pub. Date: Mar. 6, 2008

(54) PLANOGRAPHIC PRINTING PLATE MATERIAL

(76) Inventor: Kazuyoshi SUZUKI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/846,281

(22) Filed: Aug. 28, 2007

(30) Foreign Application Priority Data
Aug. 31, 2006 (JP) JP2006-235338

(51) Int. Cl. G03C 1/04

(52) U.S. Cl. 430/286.1; 430/270.1

(57) ABSTRACT

A planographic printing plate material comprising an under layer and an upper layer, each of which contains an alkali-soluble resin, accumulate on a hydrophilic support, wherein a visualizing agent is incorporated in the upper layer and an acid-decomposing compound and an acid generating agent are incorporated in the under layer.

This application is based on Japanese Patent Application No. 2006-235338 filed on Aug. 31, 2006, in Japanese Patent Office, the entire content of which is hereby incorporated by reference.

### FIELD OF THE INVENTION

The present invention relates to a planographic printing plate material provided with a positive type image forming layer utilized for a so-called computer-to-plate (hereinafter, referred to as “CTP”) system, and more specifically relates to a planographic printing plate material capable of image formation via exposure with an infrared laser and exhibiting decreased residual tint as well as superior image forming capability.

### BACKGROUND OF THE INVENTION

In recent years, in accordance with digitalization of plate making data, a so-called CTP system prevails, in which digital data is directly modulated into a laser signal which is exposed on a planographic printing plate material. Recent development of lasers has been remarkable, and particularly in solid lasers and/or semiconductor lasers, which exhibit high power and are compact, and have become readily available. These lasers are very useful as an exposure light source during direct plate making from digital data via such as a computer.

As an infrared laser planographic printing plate material, a positive type planographic printing plate provided with a recording layer, which contains (A) a resin soluble in an alkaline aqueous solution having a phenolic hydroxyl group such as a cresol-novolak resin, and (B) an infrared absorbent, has been proposed (please refer to Patent Document 1). In this positive type planographic material, an association state of a cresol-novolak resin changes by the action of heat generated by an infrared absorbent in the exposed portion to generate a solubility difference (a dissolution rate difference) compared to the non-exposed portion, and development is performed utilizing that difference to form the image. However, since the solubility rate difference is small, there was a problem of an excessively narrow development latitude.

To counter the above problem, a planographic printing plate utilizing a technology to incorporate an infrared absorbent together with a compound (such as onium salt, quinonediazide compounds and triazine compounds), which generates acid upon activation and decomposition via generated heat, or a compound which is provided with a ketal group and is decomposed in an acid (please refer to Patent Documents 2 and 3).

In the recent printing market, time reduction of the plate making process is desired due to the tendency toward smaller lots and multiple jobs. Practices to increase solubility to a developer solution, to make a planographic printing plate material highly sensitive, and to increase a conveyance rate during development, are employed to meet time reduction. However, using such means, caused problems such as generation of film thickness loss and generation of residual tint. Further, in the case of employing an acid-decomposing compound, there was a problem of causing performance variation due to aging.

[Patent Document 11 Published PCT International Application No. 97/39894

[Patent Document 2) Japanese Registration Patent No. 3644002

[Patent Document 31 Unexamined Japanese Patent Application Publication No. (hereinafter, referred to as JP-A) 7-285275

### SUMMARY OF THE INVENTION

This invention has been created in view of the above-described problems, and an object of this invention is to provide a planographic printing plate material which is capable of being exposed via an infrared laser, and characterized by superior sensitivity and good resistance against developer solution (resistance against film thickness loss), as well as excellent aging stability (resistance against sensitivity variation) and decreased residual tint generation.

### MEANS TO SOLVE THE PROBLEMS

The above object of this invention can be achieved by the following constitutions.

Item 1. A planographic printing plate material comprising an under layer and an upper layer, each of which contains alkali-soluble resin, accumulated on a hydrophilic support, wherein a visualizing agent is incorporated in the upper layer and an acid-decomposing compound and an acid generating agent are incorporated in the under layer.

Item 2. The planographic printing plate described in Item 1, wherein the aforesaid acid-decomposing compound is a compound represented by following Formula (1) or (2):

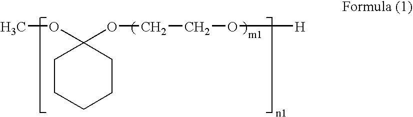

wherein, m1 is an integer of 1-4 and n1 is an integer of 2-30,

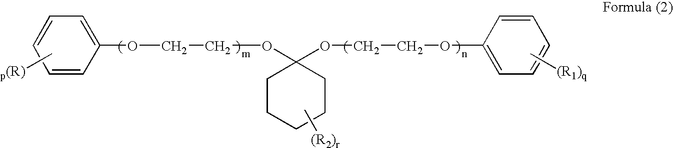

wherein, R, R₁ and R₂ are each a hydrogen atom, an alkyl group having a carbon number of 1-5, an alkoxy group having a carbon number of 1-5, a sulfo group, a carboxyl group or a hydroxyl group; p, q and r are each an integer of 1-3; and m and n are each an integer of 1-5.

Item 3. The planographic printing plate material described in Item 1 or 2, wherein the aforesaid visualizing agent is a quaternary nitrogen containing compound.

Item 4. The planographic printing plate material described in any one of Items 1-3, wherein the hydrophilic support is aluminum which has been subjected to a hydrophilicity treatment by polyvinylsulfonic acid.

Although an reaction of this invention is not fully understood, it is assumed that reduction of the insolubilization effect in a developer solution of the acid-decomposing compound contained in the under layer is induced by incorporating a visualizing agent in the upper layer, but not in the under layer, whereby exhibited are superior sensitivity and good resistance against developer solution (resistance against film thickness loss) as well as improved aging stability (resistance against sensitivity variation), and no residual tint generation due to reduced adsorption of the visualizing agent by the grain.

This invention can provide a planographic printing plate which is capable of being exposed by an infrared laser, characterized by superior sensitivity and good resistance against developer (resistance against film thickness loss) as well as excellent aging stability (resistance against sensitivity variation) and decreased residual tint generation.

### DETAILED DESCRIPTION OF THE INVENTION

In the following, the most preferable embodiment to practice this invention will be explained; however, this invention is not limited thereto.

This invention will now be further detailed.

(Support)

(Manufacturing Method of Support)

As a support for a planographic printing plate material of this invention, an aluminum support is preferably utilized, and, in this case, an aluminum support may be such as a pure aluminum plate or an aluminum-alloy plate.

Various types of aluminum alloys may be utilized, examples of which are alloys of metals such as silica, copper, manganese, magnesium, chromium, zinc, lead, bismuth, nickel, titanium, sodium and iron, with aluminum, and an aluminum plate may be manufactured by various types of rolling methods. Further, utilized may be a recycled aluminum plate, which is prepared by rolling a recycled aluminum raw metal such as scrap material or recycled material, as has prevailed in recent years.

The support utilized for the planographic printing plate material of this invention is preferably subjected to a degreasing treatment to remove manufacturing oil from the surface prior to a surface roughening treatment (being a graining treatment). As a degreasing treatment, employed are such as a degreasing treatment using a solvent such as trichlene and thinner, and an emulsion degreasing treatment using an emulsion of such as kecirone and triethanolamine. Further, in a degreasing treatment, an aqueous solution of alkaline such as caustic soda may be employed. In the case of utilizing an alkaline aqueous solution such as caustic soda for the degreasing treatment, dirt and oxidized film, which cannot be eliminated only by the above-described degreasing treatment, can be also employed. In the case of an alkaline aqueous solution having been utilized for the degreasing treatment, the aluminum support is preferably subjected to a desmutting treatment by being immersed in acid, such as phosphoric acid, nitric acid, hydrochloric acid, sulfuric acid or chromic acid, or a mixture thereof if smut exists on the support surface.

A method of surface roughening includes, for example, a mechanical method and etching via electrolysis. In an embodiment of this invention, the surface roughening method is not specifically limited, however, surface roughness Ra is preferably in the range of 0.4-0.8 μm. Further, in an embodiment of this invention, surface roughening is performed via an alternate current electrolysis in an acidic electrolytic solution, primarily comprised of hydrochloric acid.

The mechanical surface roughening method is also not specifically limited, however, a brush graining method and a honing graining method are preferred. Surface roughening by a brush graining method can be performed, for example, via rotating a rotary wire brush employing bristles having a diameter of 0.2-0.8 mm, and pressing the brush onto the support surface while supplying slurry comprised of particles such as volcanic ash exhibiting a particle size of 10-100 μm, homogeneously dispersed in water. Surface roughening by a honing graining method can be performed, for example, by ejecting particles of volcanic ash, having a particle size of 10-100 μm homogeneously dispersed in water, through a nozzle under pressure and having the particles collide with the support surface at an oblique angle.

Further, surface roughening can also be performed, for example, by adhering a sheet on which grinding particles having a particle size of 10-100 μm have been coated at a density of 2.5×10³−10×10³ particles/cm², at an interval of 100-200 μm, on the support surface, and transferring a roughening pattern of the sheet on the support surface, via pressure.

The support surface, after having been roughened by any of the mechanical surface roughening methods described above, is preferably immersed in acidic or alkaline aqueous solution to remove residue such as a grinding agent grains from the surface of the support and any aluminum particles formed (hereinafter, referred to as a desmutting treatment). Utilized as an acid may be such as sulfuric acid, persulfuric acid, hydrofluoric acid, phosphoric acid, nitric acid and hydrochloric acid, as well as such as sodium hydroxide and potassium hydroxide may be utilized as a base. Among these, the sodium hydroxide alkaline solution is preferable. The dissolution amount of aluminum from the surface is preferably 0.5-5 g/m². The support, after having been subjected to an immersion treatment in an alkaline solution, is preferably subjected to a neutralization treatment by being immersed in acid such as phosphoric acid, nitric acid, sulfuric acid or chromic acid, or in a mixture of the acids.

An electro-chemical surface roughening method is also not specifically limited, however, preferable is a method to roughen the surface electrochemically in an acid electrolytic solution, via alternate current. As an acidic electrolytic solution, an acidic electrolytic solution generally utilized in an electrochemical roughening method may be employed; however, a hydrochloric acid type or nitric acid type electrolytic solution is preferable. As an electrochemical surface roughening method, for example, utilized may be one described in Examined Japanese Patent Application Publication No. (hereinafter, referred to as JP-B) 48-28123, British Patent No. 896,563 and JP-A 53-67507. This surface roughening method is generally performed by applying voltage in a range of 1-50 volts, however, it is preferably in a range of 10-30 volts. A current density in the range of 10-200 A/dm² may be utilized, however, it is preferably selected in the range of 40-150 A/dm². The quantity of electricity in the range of 100-5,000 C/dm² may be utilized, however, it is preferably selected in the range of 100-2,500 A/dm². The temperature during this surface roughening treatment may be set in the range of 10-50° C., however, it is preferably selected in the range of 15-45° C.

In the case of electro-chemical surface roughening by use of a nitric acid type electrolytic solution, it is generally performed by application of a voltage in the range of 1-50 volts, however, a voltage is preferably selected in the range of 10-30 volt. A current density in the range of 10-200 A/dm² may be utilized, however, it is preferably selected in the range of 20-100 A/dm². The quantity of electricity in the range of 100-5,000 C/dm² may be utilized, however, it is preferably selected in the range of 100-2,500 A/dm². The temperature during the electro-chemical surface roughening treatment may be set in the range of 10-50° C., however, it is preferably selected in the range of 15-45° C. The nitric acid concentration of the electrolytic solution is preferably 0.1-5 weight %. The electrolytic solution may be appropriately incorporated such as nitrates, chlorides, amines, aldehydes, phosphoric acid, chromic acid, boric acid, acetic acid or oxalic acid.

In the case of electrochemical surface roughening by use of a hydrochloric acid type electrolytic solution, it is generally performed by application of a voltage in a range of 1-50 volts, however, a voltage is preferably selected in the range of 2-30 volts. A current density in the range of 10-200 A/dm² may be utilized, however, it is preferably selected in the range of 30-150 A/dm². The quantity of electricity in the range of 100-5,000 C/dm² may be utilized, however, it is preferably selected in the range of 100-2,500 A/dm² and more preferably in the range of 200-2,500 A/dm². The temperature during the electrochemical surface roughening treatment may be set in the range of 10-50° C., however, it is preferably selected in the range of 15-45° C. The hydrochloric acid concentration of the electrolytic solution is preferably 0.1-5 weight %. The electrolytic solution may be appropriately incorporated such as nitrates, chlorides, amines, aldehydes, phosphoric acid, chromic acid, boric acid, acetic acid or oxalic acid.

The support surface, after having been roughened by the electro-chemical surface roughening treatment described above, is preferably immersed in an acidic or alkaline aqueous solution to remove any residual such as aluminum wastes from the surface (being a desmutting treatment). Utilized as an acid may be such as sulfuric acid, persulfuric acid, hydrofluoric acid, phosphoric acid, nitric acid or hydrochloric acid, while such as sodium hydroxide and potassium hydroxide may be utilized as a base. Of these, the sodium hydroxide alkaline solution is preferable. The dissolution amount of aluminum from the surface is preferably 0.5-5 g/m². The support, after having been subjected to an immersion treatment with an alkaline solution, is preferably subjected to a neutralization treatment by being immersed in an acid such as phosphoric acid, nitric acid, sulfuric acid and chromic acid or a mixture thereof.

A mechanical surface roughening method or an electro-chemical surface roughening method may be employed separately for surface roughening, or a mechanical surface roughening method followed by an electro-chemical surface roughening method may be employed.

After the roughening treatment, an anodic oxidation treatment may be performed. A method of an anodic oxidation treatment in this invention is not specifically limited and any commonly known, but appropriate method may be utilized. Oxidation film forms on the support during the anodic oxidation treatment. For the anodic oxidation treatment, preferably utilized is a method in which an aqueous solution containing 10-50 weight % of such as sulfuric acid is employed as an electrolytic solution. Electrolysis is typically performed at a current density of 1-50 A/dm², however, also utilized may be a method such as when electrolysis is performed at a high current density in sulfuric acid, as described in U.S. Pat. No. 1,412,768, a method in which electrolysis is performed by using phosphoric acid as described in U.S. Pat. No. 3,511,661, or a method utilizing a solution containing one or not less than two types of such as chromic acid, oxalic acid or malonic acid. The typical coverage of anodic oxidation film is 3.0-4.0 g/m². The coverage of anodic oxidation film can be determined, for example, by immersing an aluminum plate in a phosphoric chromic acid solution (prepared by dissolving 35 ml of a 85% phosphoric acid solution and 20 g of chromium (IV) oxide in 1 L of water) to dissolve oxidation film, and measuring a weight change between before and after dissolution of oxidation film of the plate.

By removing anodic oxidation film after anodic oxidation to observe the surface, it is possible to confirm cells of anodic oxidation and to measure a length thereof, whereby a cell size of anodic oxidation can be determined. A cell size of oxidation film of this invention is 30-80 μm and preferably 40-70 μm. By setting a cell size in the above range, there exhibited little development sludge and excellent anti-abrasion resistance even in long term usage of the plate.

The support having been anodic oxidation treated may be appropriately subjected to a sealing treatment. The sealing treatment can be performed by a commonly known method such as a hot water treatment, a boiling water treatment, a vapor treatment, a sodium silicate treatment, a dichromate aqueous solution treatment, a nitrite treatment and an ammonium acetate treatment.

Since a finely roughened surface constituted of a roughened portion, having a mean interval or a mean size of 30-150 nm, of this invention is difficult to be formed by a mechanical roughening method or an alternate current electrolytic roughening method with a nitric acid type electrolytic solution, it is necessary to be formed by a sealing treatment. In this case, a hot water treatment or an ammonium acetate treatment is preferable. In the case of a hot water treatment, a desired finely roughened surface can be prepared by combining conditions in a range of a temperature of 70-97° C. and a processing time of 5-180 seconds. Further, a desired finely roughened surface can be prepared in shorter time by adjusting pH to 7-9.5 with ammonium acetate.

On the other hand, finely roughened surface can be formed by an alternate current electrolytic roughening method in a hydrochloric acid type electrolytic solution, however, can be reformed by the above-described hot water treatment or ammonium acetate treatment, when the finely roughened surface also has been dissolved by a desmut treatment. Further, the fine structure may be also formed by a combination of a condition of a desmut treatment with a hot water treatment or an ammonium acetate treatment.

(Under Coating Layer (Hydrophilicity Treatment))

Further, in this invention, a hydrophilicity treatment is preferably performed after these treatments. By this treatment, chemical resistance will be improved due to improvement of adhesion property between a support and the under layer. Further, a hydrophilicity treatment layer functions as a heat insulating layer and heat generated by exposure of an infrared laser will not diffuse into a support to efficiently utilize a reaction of such as an acid-decomposing compound, resulting in increased sensitivity.

A hydrophilicity treatment is not specifically limited, however, those undercoated with a water soluble resin such as polyvinylphosphonic acid, polyvinyl alcohol and derivatives thereof, carboxymethyl cellulose, dextrin, gum arabi, sulfonic acids having an amino group such as 2-aminoethyl sulfonic acid, polymer and copolymer having a sulfonic acid group in the side chain, polyacrylic acid, water-soluble metal salt (such as zinc borate), yellow dye and amine salt, can be utilized. Further, a sol-gel treated substrate on which a functional group capable of causing an addition reaction by a radical covalently bonded, as disclosed in JP-A 5-304358, can be also utilized. It is preferable to provide a hydrophilicity treatment on the support surface by polyvinyl phosphonic acid.

Further, as a hydrophilicity treatment material, water-soluble infrared dye can be utilized. It is preferable to utilize water-soluble infrared dye because improvement of a function as a heat insulating layer, inhibition of heat generated by exposure of an infrared laser from diffusing into a support and a function as a photo-thermal conversion compound characteristic to infrared dye, can be compatible. Infrared dye is not specifically limited provided being well known in the art and water soluble. For example, listed are ADS 830WS (Shiebel-Hegner Japan) as cyanine type dye and those having sulfonic acid or sulfonate such as NK-4777 (Hayashi Biological Science Laboratory).

A treatment method is not specifically limited and includes a coating method, a spray method and a dip method, however, preferable is a dip method to achieve cost down of facilities. In the case of a dip method, it is preferable to perform a treatment with a 0.05-3% polyvinylphosphonic acid aqueous solution. A treatment temperature of 20-90° C. and a treating time of 10-180 seconds are preferable. After the treatment, it is preferable to perform a squeezing treatment or a washing treatment to remove excessively accumulated polyvinylphosphonic acid. Further, drying treatment is preferably performed.

The drying temperature is preferably 40-180° C. and more preferably 50-150° C. Application of a drying treatment is preferable because of improvement of adhesion with the under layer and a function as a heat insulating layer, in addition to improvement of chemical resistance and sensitivity.

The layer thickness of a hydrophilicity treatment layer is preferably 0.002-0.1 μm and more preferably 0.005-0.05 μm. It is not preferable because sufficient adhesion property and insulating property cannot be achieved in the case of less than 0.002 μm, while it is not preferable because adhesion with the under layer becomes excessively strong to deteriorate solubility at development resulting in deteriorated sensitivity in the case of over 0.1 μm.

(Surface Shape of Support)

The surface shape of a support is preferably provided with a grain shape in which a medium wave structure having a mean opening diameter of 5.0-10.0 μm and a small wave structure having a mean opening diameter of 0.5-3.0 μm and a mean ratio of a depth to an opening diameter of not less than 0.2 are accumulated.

In this invention, a medium wave structure having a mean opening diameter of 5.0-10.0 μm has a function to hold an image recording layer and to provide printing durability, mainly by an anchor effect.

A small wave structure having a mean opening diameter of 0.5-3.0 μm and a mean ratio of a depth to an opening diameter of not less than 0.2 which is accumulated on a medium wave structure functions to increase sensitivity while restraining decrease of printing durability to be minimum. By combining a specific small wave structure on a specific medium wave structure, it is considered that development speed is improved because a developer solution can easily penetrate into the interface of a support/an image recording layer.

The above-described structure, in which a medium wave structure and a small wave structure are accumulated, may be further accumulated with a large wave structure having a mean wave length of 5.0-100 μm. This large wave structure has a function to increase a water retention amount on the surface of a non-image portion of a planographic printing plate. When the amount of water retained on the surface is the larger, the surface of a non-image portion become hardly affected by dirt in the atmosphere, whereby a non-image portion which hardly accepts dirt even when the plate is left on the way of printing, can be prepared. Further, when a large wave structure is accumulated, it becomes easy to visually confirm the amount of dampening water provided on the plate surface at the time of printing. That is, plate inspection property becomes excellent.

In a support of this invention, measurement methods of a mean opening diameter of a medium wave structure, a mean opening diameter and a mean ratio of a depth to an opening diameter of a small wave structure, and a mean wave length of a large wave, of the surface are as follows.

(1) Mean Opening Diameter of Medium Wave Structure

The surface of a support is photographed from right over by use of an electronmicroscope at a magnification of 2,000 times, and at least 50 pits from the pits of a medium wave structure (medium wave pits), circumferences of which are connected, in the obtained electronmicroscopic picture were extracted to read a diameter thereof as an opening diameter, whereby a mean opening diameter is calculated. In the case of a structure in which a large wave structure being accumulated, measurement is performed also according to the same method.

Further, to restrain scatter of measurement, equivalent circle diameter measurement by use of an image analyzing software available on the market may also be performed. In this case, the above-described electronmicroscopic picture was read by a scanner to be digitized and an equivalent circle diameter is determined after the data have been converted into binary data.

According to measurement by the inventors, the result of visual measurement and the result of digital processing showed approximately the same value.

(2) Mean Opening Diameter of Small Wave Structure

The surface of a support is photographed from right over by use of a high resolution scanning electronmicroscope (SEM) at a magnification of 50,000 times, and at least 50 pits from the pits of a small wave structure (small wave pits) in the obtained electronmicroscopic picture were extracted to read a diameter thereof as an opening diameter, whereby a mean opening diameter is calculated.

(3) Mean Ratio of Depth to Opening Diameter in Small Wave Structure

As for a mean ratio of a depth to an opening diameter in a small wave structure, a cross sectional plane of a support is photographed by use of a high resolution SEM at a magnification of 50,000, and at least 20 pits from the small wave pits in the obtained SEM picture were extracted to read the opening diameter and the depth, whereby the ratio is determined to calculate the mean value.

(4) Mean Wavelength of Large Wave Structure

Two-dimensional roughness measurement is performed by use of a stylus type roughness meter, and a mean peak interval S m is measured five times to determine the average as a mean wavelength.

<Alkaline-Soluble Resin>

Alkaline-soluble resin according to this invention will now be explained.

(Alkaline-Soluble Resin in Upper Layer)

Alkaline-soluble resin utilizable in the upper layer of a planographic printing plate material of this invention will now be explained.

(Resin Having Phenolic Hydroxyl Group)

Resin which has a phenolic hydroxyl group and is utilizable in this invention includes novolac resin which is formed by condensation of phenols with aldehydes. Phenols include such as phenol, m-cresol, p-cresol, m-/p- mixed cresol, phenol and cresol (any one of m-, p- or m-/p-mixture), pyrogallol, acrylamide having a phenol group, methacrylamide, acrylic ester, methacrylic ester or hydroxystyrene. Further, also listed are isopropyl phenol, t-butyl phenol, t-amyl phenol, hexyl phenol, cyclohexyl phenol, 3-methyl-4-chloro-6-t-butyl phenol, isopropyl cresol, t-butyl cresol and t-amyl cresol. Preferably utilized are t-butyl phenol and t-butyl cresol. On the other hand, examples of aldehydes include aliphatic and aromatic aldehyde such as formaldehyde, acetoaldehyde, acrolein and crotonaldehyde. Preferable is formaldehyde or acetoaldehyde and specifically preferable is formaldehyde.

Among the above combinations, preferable are phenol-formaldehyde, m-cresol-formaldehyde, p-cresol-formaldehyde, m-/-p-mixed cresol-formaldehyde and phenol/cresol (any one of m-, p-, o-, M-/p-mixture, m-/o-mixture and o-/p-mixture) mixture-formaldehyde. Specifically preferable is (m-/p-mixed) cresol-formaldehyde.

These novolak resins preferably have a weight average molecular weight of not less than 1,000 and a number average molecular weight of not less than 200. More preferable are those having a weight average molecular weight of 1,500-300,000 and a number average molecular weight of 300-250,000, and a degree of dispersion (weight average molecular weight/number average molecular weight) of 1.1-10. Specifically preferable are those having a weight average molecular weight of 500-10,000, a number average molecular weight of 2,000-10,000 and a degree of dispersion (weight average molecular weight/number average molecular weight) of 1.1-5. By employing the above-described range, such as film strength, alkaline solubility, solubility against chemicals and interaction with a photo-thermal conversion compound of novolak resin can be suitably controlled. Further, a weight average molecular weight can be adjusted depending on the upper layer and the under layer. In the upper layer, since such as chemical resistance and film strength are required, a weight average molecular weight is preferably relatively high as 2,000-10,000. Herein, as a weight average molecular weight of novolak resin in this invention, a polystyrene converted value which is determined by a gel permeation chromatography (GPC) method employing mono-dispersed polystyrene as a standard is applied.

As a manufacturing method of novolak resin according to this invention, for example, as described in “New Experimental Chemistry Course [19], Polymer Chemistry [I]” (1993, Maruzen Shuppan), item No. 300, phenol and substituted phenols (such as xylenols and cresols) are reacted together with a formaldehyde aqueous solution utilizing acid as a catalyst to perform dehydration condensation of phenol, the opposition or p-position in a substituted phenol component, and formaldehyde. Novolak resin thus prepared, after having been dissolved in an organic polar solvent, is added with a suitable amount of a non-polar solvent, followed by being kept for a few hours, whereby a novolak resin solution is separated into two layers. By concentrating only the under layer of the separated solution, novolak resin having an intensive molecular weight can be prepared.

An organic polar solvent utilized includes such as acetone, methyl alcohol and ethyl alcohol. A non-polar solvent includes such as hexane and petroleum ether. Further, in addition to the above-described manufacturing method, for example, as described in Japanese Translation of PCT International Application Publication No. 2001-506294, novolak resin can be obtained by forming precipitation by addition of water after novolak resin is dissolved in water-soluble organic polar solvent. Further, to prepare novolak resin having a small degree of dispersion, employed can be a method in which novolak resin prepared by dehydration condensation of phenol derivatives each other, after having been dissolved in an organic polar solvent, is treated by silica gel for molecular weight classification.

Dehydration condensation of phenol, the o-position or p-position of a substituted phenol component and formaldehyde can be performed by adding formaldehyde into a solvent solution having the total weight of phenol and a substituted phenol component of 60-90 weight % and preferably 70-80 weight % as a concentration, to make a mol ratio of formaldehyde against the total mol number of phenol and a substituted phenol component of 0.2-2.0, preferably of 0.4-1.4 and specifically preferably of 0.6-1.2, and further adding an acid catalyst to make the mol ratio against the total mol number of phenol and a substituted phenol component of 0.01-0.1 and preferably of 0.02-0.05, under a temperature condition in a range of 10-150° C., followed by being stirred for a few hours while keeping the temperature range. Herein, a reaction temperature is preferably in a range of 70-150° C. and more preferably in a range of 90-140° C.

A solvent utilized includes such as water, acetic acid, methanol, ethanol, 2-propanol, 2-methoxyethanol, ethylpropionate, ethoxyethylpropionate, 4-methyl-2-pentanone, dioxane, xylene and benzene.

Further, the above-described catalyst includes such as hydrochloric acid, sulfuric acid, p-toluenesulfonic acid, phosphoric acid, oxalic acid, tartaric acid, citric acid, zinc acetate, manganese acetate, cobalt acetate, magnesium methylsulfonate, aluminum chloride and zinc oxide. Residual monomer and dimmer in the synthesized phenol resin are preferably eliminated by evaporation.

In the above description, general controlling methods of a molecular weight were listed, however, a preparation method of novolak resin having preferable physical properties for this invention is not limited thereto, and, it is needless to say that a method well known in the art, such as to control molecular weight distribution by employing a specific acid catalyst and solvent, can be appropriately applied.

Novolak resin according to this invention may be utilized alone or at least two types may be utilized in combination. It is preferable to combine not less than two types because different characteristics such as film strength, alkaline solubility, solubility against chemicals, and an interaction with a photo-thermal conversion compound can be efficiently utilized. In the case of utilizing at least two types of novolak resin in an image recording layer, to combine those having as much difference as possible in such as a weight average molecular weight and an m/p ratio. For example, it is preferable to provide a difference of not less than 1,000 and more preferably not less than 2,000, in a weight average molecular weight; and a difference of not less than 0.2 and more preferably not less than 0.3, in an m/p ratio.

The addition amount of resin having a phenolic hydroxyl group against the total solid in an image recording layer in a planographic printing plate material of this invention is preferably in a range of 30-90 weight %, more preferably of 35-85 weight % and most preferably of 40-80 weight %, in view of such as chemical resistance and printing durability as for the upper layer.

Further, novolak resin is preferably made to be reacted to introduce a specific substituent. A specific substituent can be synthesized by performing a reaction with an intermediate which is a reaction product of amine and diisocyanate.

Utilizable amine is not specifically limited; however, the following compounds are specifically preferable.

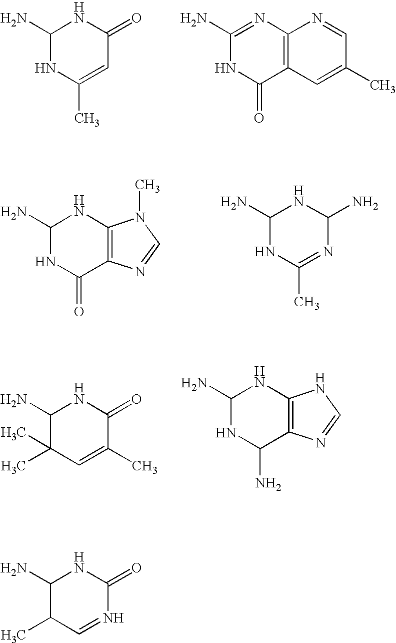

Diisocyanate is not also specifically limited; however, the following compounds are preferred.

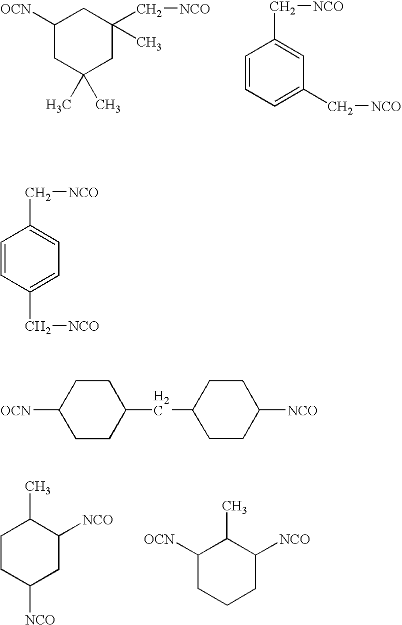

Novolak type and acrylic type resin, to which a specific substituent has been introduced, can be utilized either alone or in combination.

(Acrylic Resin)

Acrylic resin utilizable in this invention is preferably copolymer containing the following constituent unit. A constituent unit preferably utilized includes constituent units derived from monomer well known in the art such as acrylic esters, methacrylic esters, acrylamides, methacrylamides, vinylesters, styrenes, acrylic acid, methacrylic acid, acrylonitrile, maleic acid anhydride, maleic acid imide and lactones.

Specific examples of utilizable acrylic esters include methyl acrylate, ethyl acrylate, (n- or i-) propyl acrylate, (n-, i-, sec- or t-) butyl acrylate, amyl acrylate, 2-ethylhexyl acrylate, dodecyl acylate, chloroethyl acrylate, 2-hydroxyethyl acrylate, 2-hydroxypropyl acrylate, 5-hydroxypentyl acrylate, cyclohexyl acrylate, allyl acrylate, trimethylolpropane monoacrylate, pentaerythritol monoacrylate, glycidyl acrylate, benzyl acrylate, methoxybenzyl acrylate, chlorobenzyl acrylate, 2-(p-hydroxyphenyl)ethyl acylate, furfryl acrylate, tetrahydrofurfryl acrylate, phenyl acrylate, chlorophenyl acrylate and sulfamoylphenyl acrylate.

Specific examples of utilizable methacrylic esters include methyl methacrylate, ethyl methacrylate, (n- or i-) propyl methacrylate, (n-, i-, sec- or t-) butyl methacrylate, amyl methacrylate, 2-ethylhexyl methacrylate, dodecyl methacylate, chloroethyl methacrylate, 2-hydroxyethyl methacrylate, 2-hydroxypropyl methacrylate, 5-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, 2-(p-hydroxyphenyl)ethyl methacylate, furfryl methacrylate, tetrahydrofurfryl methacrylate, phenyl methacrylate, chlorophenyl methacrylate and sulfamoylphenyl methacrylate.

Specific examples of acrylamides include such as acrylamide, N-methylacrylamide, N-ethylacryamide, N-propylacrylamide, N-butylacrylamide, N-benzylacrylamide, N-hydroxyethlacrylamide, N-phenylacrylamide, N-tolylacrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, N-hydroxyethyl-N-methylacrylamide and N-(p-toluenesulfonyl)acrylamide.

Specific examples of methacrylamide include such as methacrylamide, N-methylmethacrylamide, N-ethylmethacryamide, N-propylmethacrylamide, N-butylmethacrylamide, N-benzylmethacrylamide, N-hydroxyethlmethacrylamide, N-phenylmethacrylamide, N-tolylmethacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide, N-(p-toluenesulfonyl)methacrylamide and N-hydroxyethyl-N-methylacrylamide.

Specific examples of lactone include pantoyl lactone (meth) acrylate, α-(meth) acryloyl-γ-butyrolactone and β-(meth) acryloyl-γ-butyrolactone.

Specific examples of maleic acid imides include such as maleimide, N-acryloylacrylamide, N-acetylmethacrylamide, N-propionylmethacrylamide and N-(p-chlorobenzoyl)methacrylamide.

Specific examples of vinyl esters include such as vinyl acetate, vinyl butyrate and vinyl benzoate.

Specific examples of styrenes include such as styrene, methystyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostylene, fluorostyrene and carboxystyrene.

Specific examples of acrylonitrile include such as acrylonitrile and methacrylonitrile.

Among these monomers, preferably utilized are acrylic esters methacrylic esters, acrylamides, methacrylamides, acrylic acid, methacrylic acid, acrylonitriles, maleic acid imides and the following compounds, which have a carbon number of not more than 20.

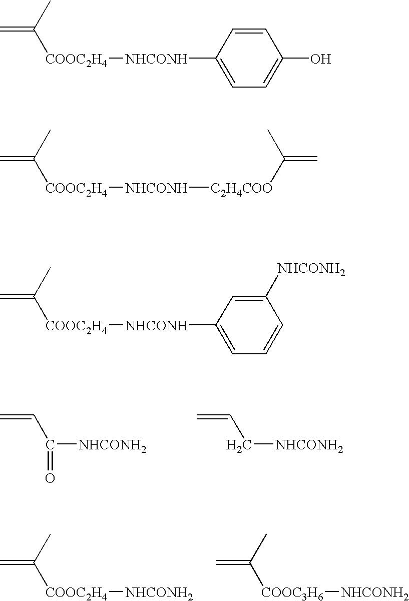

A molecular weight of copolymer utilizing these is preferably not less than 2,000, furthermore preferably in a range of 5,000-100,000 and specifically preferably 10, 000-50,000 based on a weight average molecular weight (Mw). By setting a molecular weight in the above described range, film strength, alkaline solubility and solubility against chemicals can be controlled resulting in easy achievement of the effects of this invention. On the other hand, a polymerization form of acrylic resin of this invention may be any one of such as random polymer, block polymer or graft polymer, however, block polymer which is capable of phase separation of a hydrophilic group and a hydrophobic group is preferable in view of capability of controlling such as dissolution in a developer solution.

Acrylic resin utilizable in this invention may be utilized either alone or in combination of not less than two types.

(Other Resin)

As alkaline soluble resin of this invention, in addition to the aforesaid novolak resin and acrylic resin, either of urethane resin and acetal resin can be incorporated. By addition of the above-described resin, chemical resistance is significantly improved.

Further, alkaline soluble resin other than the above-described two types can be utilized in combination within a range not to disturb the effects of this invention. Other alkaline soluble resin, which can be incorporated, includes polyamide resin, polyester resin, cellulose resin, polyvinyl alcohol and derivatives thereof, polyvinyl pyrrolidone, epoxy resin and polyimide.

(Acetal Resin)

Polyvinyl acetal resin utilizable in this invention can be synthesized by a method to acetalize polyvinyl alcohol by aldehyde and to perform reaction of the residual hydroxyl groups with acid anhydride. Aldehyde utilized in this method includes formaldehyde, acetoaldehyde, propionaldehyde, butylaldehyde, pentylaldehyde, hexylaldehyde, glyoxylic acid, N,N-dimethylformaldehyde, n-butylaldehyde, bromoacetoaldehyde, chloroactoaldehyde, 3-hydroxy-n-butylaldehyde, 3-methoxy-n-butylaldehyde, 3-(dimethylamino)-2,2-dimethylpropionaldehyde and cyanoaldehyde, however, is not limited thereto.

A structure of acetal resin is preferably polyvinyl acetal resin represented by following Formula (I).

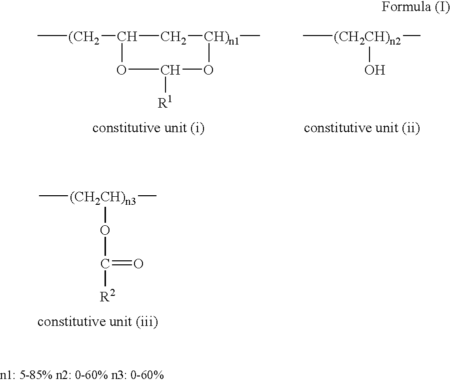

Polyacetal resin represented by above-described Formula (I) is comprised of constitutive unit (i) as a vinyl acetal component, constitutive unit (ii) as a vinyl alcohol component and constitutive unit (iii) as au unsubstituted ester component among the aforesaid constitutive units, and can be provided with at least one type of each constitutive unit. Herein, n1-n3 are a constitutive ratio (mol %) of each constitutive unit.

In above-described constitutive unit (i), R¹ is an alkyl group may be provided with a substituent, a hydrogen atom, a carboxyl group or a dimethylamino group. The substituent includes a carboxyl group, a hydroxyl group, a chloro group, a bromo group, an urethane group, an ureide group, a tertiary amino group, an alkoxy group, a cyano group, a nitro group, an amido group and an ester group. Specific examples of R¹ include a hydrogen atom, a metyl group, an ethyl group, a propyl group, a butyl group, a pentyl group, a carboxyl group, an methyl group substituted by a halogen atom (such as —Br, —Cl) or a cyano group, a 3-hydroxybutyl group, a 3-methoxybutyl group and a phenyl group; and among them, a hydrogen atom, a propyl group and a phenyl group are specifically preferable.

Further, n1 is preferably in a range of 5-85 mol % and specifically preferably in a range of 25-70 mol %. Film strength becomes weak when n1 is less than 5 mol % to deteriorate printing durability, while the resin composition becomes hardly soluble in a coating solvent when n1 is over 85 mol %, which is not preferable. In above-described constitutive unit (ii), n2 is preferably in a range of 0-60 mol % and specifically preferably in a range of 10-45 mol %. Since this constitutive unit is excellent in compatibility with water, swelling property against water increases to deteriorate printing durability in the case that n2 is over 60 mol %.

In above-described constitutive unit (iii), R² is an alkyl group without a substituent; an aliphatic hydrocarbon group, an alicyclic hydrocarbon group or an aromatic hydrocarbon group which is provided with a carboxyl group; and these hydrocarbon groups have a carbon number of 1-20. Among them, an alkyl group having a carbon number of 1-10 is preferable and a methyl group and an ethyl group are specifically preferable with respect to developability. n3 is preferably in a range of 0-20 mol % and specifically preferably in a range of 1-10 mol %. It is not preferable that printing durability is deteriorated when n3 is over 20 mol %.

An acid content of polyvinyl acetal resin according to this invention is preferably in a range of 0.5-5.0 meq/g (that is, 84-280 based on mg number of KOH) and more preferably in a range of 1.0-3.0 meq/g. It is not preferable because an interaction with a photo-thermal conversion compound becomes insufficient to deteriorate sensitivity when the content is less than 0.5 meq/g. On the other hand, it is not preferable because solubility in a developer solution decreases to deteriorate sensitivity and development latitude.

Further, a molecular weight of polyvinyl acetal according to this invention is preferably approximately 5,000-400,000 and more preferably approximately 20,000-300,000, based on a weight average molecular weight measured by means of gel permeation chromatography. By setting the above-described range, such as film strength, alkaline solubility and solubility against chemicals can be controlled, resulting in easy achievement of the effects of this invention.

Herein, these polyacetal resins may be utilized either alone or by mixing at least two types.

Acetalation of polyvinyl alcohol can be performed by a method well known in the art, which is described in such as U.S. Pat. Nos. 4,665,124, 4,940,646, 5,169,898, 5,700,619 and 5,792,823; and Japanese Registered Patent No. 09328519.

(Polyurethane Resin)

Polyurethane resin utilized in this invention is not specifically limited, however, alkaline soluble polyurethane resin, which contains not less than 0.4 meq/g of a carboxyl group, described in JP-A Nos. 5-281718 and 11-352691 is preferable. Specifically, preferable is polyurethane resin having a basic skeleton of a constitutive unit represented by a reaction product of a diisocyanate compound and a diol compound having a carboxyl group. As a diol compound, a diol compound having no carboxyl groups is preferably utilized in combination to adjust the carboxyl group content and to control physical properties.

The diisocyanate compound described above includes, for example, an aromatic diisocyanate compound such as 2,4-tolylene diisocyanate, dimmer of 2,4-tolylene diisocyanate, 2,6-tolylene diisocyanate, p-xylene diisocyanate, m-xylene diisocyanate, 4,4′-diphenylmethane diisocyanate, 1,5-naphthylene diisocyanate and 3,3′-dimethylbiphenyl-4,4′-diisocyanate; an aliphatic disocyanate compound such as hexamethylene diisocyanate, trimethylhexamethylene diisocyanate, lysine diisocyanate and dimer acid diisocyanate; an alicyclic diisocyanate compound such as isophorone diisocyanate, 4,4′-methylenebis(cyclohexylisocyanate), methylcyclohexane-2,4(or 2,6) diisocyanate and 1,3-(isocyanatemethyl)cyclohexane; and diisocyanate compound as a reaction product of diol and diisocyanate such as an adduct of 1 mol of 1,3-butyleneglycol and 2 mols of tolylene diisocyanate.

A diol compound having a carboxyl group includes such as 3,5-dihydroxy benzoic acid, 2,2-bis(hydroxyethyl) propionic acid, 2,2-bis(hydroxyethyl) propionic acid, 2,2-bis(3-hydroxypropyl) propionic acid, bis(hydroxymethyl) acetic acid, bis(4-hydroxyphenyl) acetic acid, 2,2-bis(hydroxymethyl) butyric acid, 4,4-bis(4-hydroxyphenyl)pentanoic acid, tartaric acid, N,N-dihydroxyethyl glycine and N,N-bis(2-hydroxyethyl)-3-carboxy-propionamide. Other diol compounds include such as ethylene glycol, diethylene glycol, triethylene glycol, tetraethylene glycol, propylene glycol, dipropylene glycol, polyethylene glycol, polypropylene glycol, neopentyl glycol, 1,3-butylene glycol, 1,6-hexanediol, 2-butene-1,4-diol, 2,2,4-trimethyl-1,3-pentanediol, 1,4-bis-β-hydroxyethoxycyclohexane, cyclohexane dimethanol, tricyclodecane dimethanol, hydrogenated bisphenol A, hydrogenated bisphenol F, an ethylene oxide adduct of bisphenol A, a propylene oxide adduct of bisphenol A, an ethylene oxide adduct of bisphenol F, a propylene oxide adduct of bisphenol F, an ethylene oxide adduct of hydrogenated bisphenol A, a propylene oxide adduct of hydrogenated bisphenol A, hydroquinone dihydroxyethyl ether, p-xylene glycol, dihydroxyethylsulfon, bis(2-hydroxyethyl)-2,4-tolylene dicarbamate, 2,4-tolylene-bis(2-hydroxyethlcarbamide), bis(2-hydroxyethyl)-m-xylylenecarbamate and bis(2-hydroxyethyl) isophthalate.

Polyurethane resin suitable for this invention includes polyurethane resin comprising a basic skeleton of a structural unit derived from a compound which is prepared by an open ring reaction of tetracarboxylic acid dianhydride with a diol compound. A method to introduce the structural unit into polyurethane resin includes, for example, a) a method to perform a reaction of an alcohol terminal compound, which is prepared by an open ring reaction of tetracarboxylic acid dianhydride with a diol compound, with a diisocyanate compound; and b) a method to perform a reaction of an alcohol terminal urethane compound, which is prepared by a reaction of diisocyanate compound under a condition of an excess amount of a diol compound, with tetracarboxylic dianhydride.

Further, a molecular weight of polyurethane resin of this invention is preferably not less than 1,000 and more preferably in a range of 5,000-500,000, based on a weight average molecular weight.

(Alkaline Soluble Resin in Under Layer)

Alkaline soluble resin utilized in the under layer in this invention can be appropriately selected from those described above which can be utilized in the upper layer. In this invention, a photo-thermal conversion compound is not contained in the under layer, wide development latitude can be assured utilizing characteristics of alkaline soluble resin. Further, it is also important to select alkaline soluble resin in consideration of such as compatibility with such as acid-decomposing compound, photo-induced acid generating agent and a photo-induced radial generator, which can be incorporated in the under layer, and the constitution of the under layer is preferably any one of the following 5 constitutions:

(1) Novolak resin, (2) Novolak resin+acrylic resin, (3) Novolak resin+acetal resin, (4) Acrylic resin, (5) Acetal resin

Since, with respect to novolak resin utilized in the under layer, such as alkaline solubility and development latitude are required, the weight average molecular weight is preferably relatively lower than the case of in the upper layer, such as 1,000-5,000. Herein, a weight average molecular weight of novolak resin in this invention applies a polystyrene converted value determined by means of gel permeation chromatography employing monodispersed polystyrene as a standard. Further, the addition amount of novolak resin is 1-70 weight % and more preferably 3-50 weight %, in view of such as high sensitivity and developability.

<Additive>

(Photo-Thermal Conversion Compound)

A photo-thermal conversion compound utilized in the upper layer of this invention is those having a light absorbing region in an infrared region of not shorter than 700 nm and preferably of 750-1,200 nm, and exhibiting light/heat conversion ability; specifically utilized can be various types of dye or pigment which absorbs light of this wavelength range to generate heat.

(Dye)

As dye, those well known in the art such as dye available on the market and those described in a literature (for example, “Dye Handbook” edited by Society of Organic Synthetic Chemistry, 1960) can be utilized. Specifically, listed are dyes such as an azo dye, metal complex azo dye, pyrazolone azo dye, anthraquinone dye, phthalocyanine dye, carbonium dye, quinoimine dye, methine dye and cyanine dye. In this invention, among these pigments or dyes, those absorbing infrared light or near infrared light are specifically preferred, because they are suitably applied for use of a laser which emits infrared light or near infrared light. Such dyes which absorb infrared light or near infrared light include, for example, a cyanine dye described in such as JP-A Nos. 58-125246, 59-84356, 59-202829 and 60-78787; a methine dye described in such as JP-A Nos. 58-173696, 58-181690 and 58-194595; a naphthoquinone dye described in such as JP-A Nos. 58-112793, 58-224793, 59-48187, 59-73996, 60-52940 and 60-63744; a squarylium dye described in such as JP-A 58-11792; and a cyanine dye described in British Patent No. 434,875. Further, as a dye, an infrared absorbing sensitizer described in U.S. Pat. No. 5,156,938 is also preferably utilized. Further, in addition to these dyes, a substituted arylbenzo(thio)pyrylium salt described in U.S. Pat. No. 3,881,924; a trimethinthiapyrylium salt described in JP-A 57-142645 (also in U.S. Pat. No. 4,327,169); pyrylium type compounds described in JP-A Nos. 58-181051, 58-220143, 59-41363, 59-84248, 59-84249, 59-146063 and 59-146061; a cyanine dye described in JP-A 59-216146; a pentamethyin thiopyrylium salt described in U.S. Pat. No. 4,283,475; and pyrilium compounds disclosed in JP-B Nos. 5-13514 and 5-19702; and Epolight III-178, Epolight III-130 and Epolight III-125, are specifically preferably utilized.

Among these dyes, specifically preferable are a cyanine dye, a phthalocyanine dye, an oxonol dye, a squarylium dye, a pyrilium dye, a thiopyrilium dye and a nickel thiolate complex. Further, a cyanine dye represented by following Formula (a) is most preferable because of providing high interaction with alkaline soluble resin, as well as being excellent in stability and economy in the case of being utilized in an image forming material according to this invention.

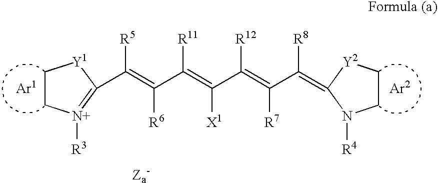

In Formula (a), X¹ is a hydrogen atom, a halogen atom, —NPh₂, X²-L¹ or a group shown below. Herein, X² is an oxygen atom or a sulfur atom, L¹ is hydrocarbon having a carbon number of 1-12, an aromatic ring having a hetero atom, or a hydrocarbon group containing a hetero atom and having a carbon number of 1-12. Herein, a hetero atom indicates N, S, O, a halogen atom or Se.

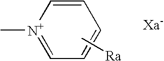

In the above-described formula, Xa is defined similarly to Za which will be described later, and Ra is a substituent selected from a hydrogen atom, an alkyl group, an aryl group, a substituted or unsubstituted amino group and a halogen atom. R¹¹ and R¹² are each independently preferably a hydrocarbon group having a carbon number of at least two, and are specifically preferable to form a 5-member ring or a 6-member ring by bonding to each other.

Ar¹ and Ar² each may be same or different, and are an aromatic hydrocarbon group which may be provided with a substituent. A preferable arcmatic hydrocarbon group includes a benzene ring and a naphthalene ring. Further, a preferable substituent includes a hydrocarbon group having a carbon number of not more than 12, a halogen atom, and an alkoxy group having a carbon number of not more than 12. Y¹ and Y² each may be same or different, and are sulfur atoms or a dialkylmethylene groups having a carbon number of not more than 12. R³ and R⁴ each may be same or different, and are a hydrocarbon group having a carbon number of not more than 20, which may be provided with a substituent. A preferable substituent includes an alkoxy group having a carbon number of not more than 12, a carboxyl group and a sulfo group. R⁵, R⁶, R⁷ and R⁸ each may be same or different, and are a hydrogen atom or a hydrocarbon group having a carbon number of not more than 12; and are preferably a hydrogen atom with respect to easy availability of a raw material. Further, Za⁻ is a counter anion. However, Za⁻ is not necessary when cyanine dye represented by Formula (a) is provided with an anionic substituent in the structure not to require neutralization of an electric charge. Za⁻ is preferably a halogen ion, a perchlorate ion, a tetrafluoroborate ion, a hexafluorophosphate ion and a sulfonic acid ion; and specifically preferably a perchlorate ion, hexafluorophosphate ion and arylsulfonic acid ion.

Specific examples of cyanine dye represented by Formula (a), which can be preferably utilized in this invention, in addition to those exemplified in the following, includes those described in paragraph Nos. (0017]-[0019] of JP-A 2001-133969, paragraph Nos. [0012]-[0038] of JP-A 2002-40638 and paragraph Nos. [0012]-[0023] of JP-A 2002-23360.

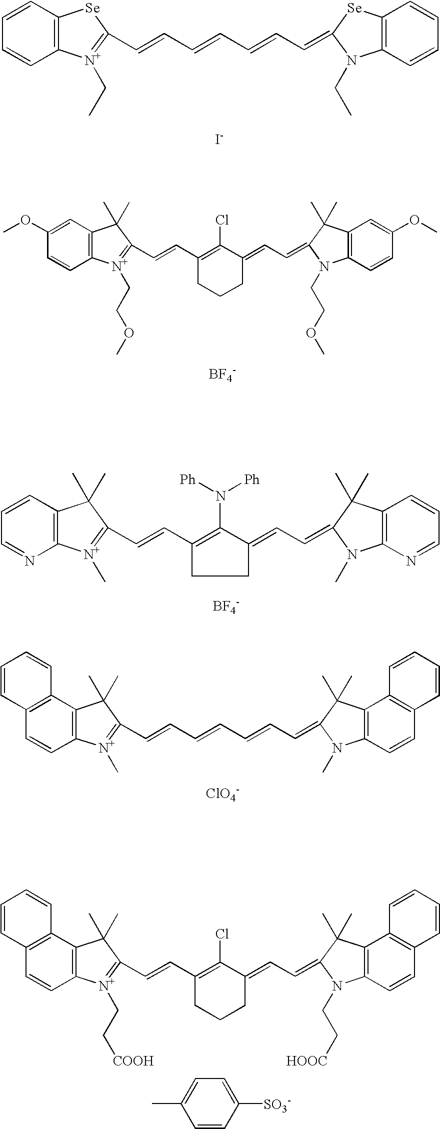

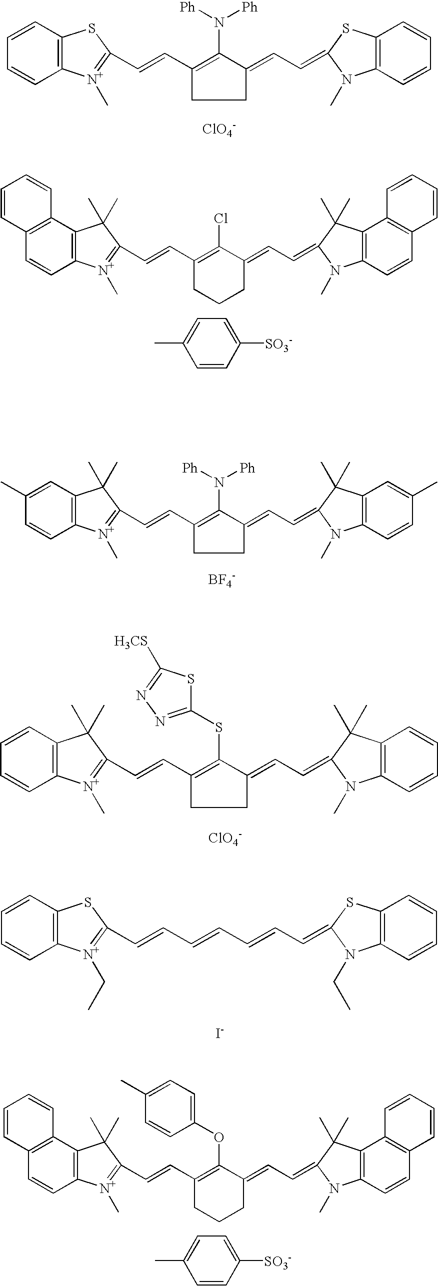

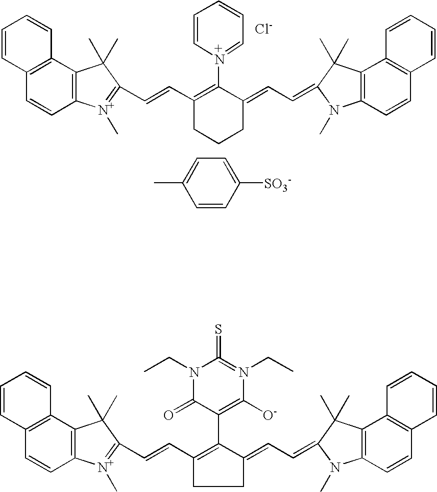

Infrared absorpotion dye can be added at a ratio of 0.01-30 weight %, preferably 0.1-10 weight % and specifically preferably 0.1-7 weight %, against the total solid constitututing the upper layer, with respect to sensitivity, chemical resistance and printing durability.

As pigment, pigment described in Color Index (C. I.) Handbook, “Newest Pigment Handbook” (edited by Society of Japan Pigment Technologies, 1997), “Newest Pigment Application Technologies” (CMC Shuppan, 1986) and “Printing Ink Technologies” (CMC Shuppan, 1984) can be utilized.

Types of pigment include black pigment, yellow pigment, orange pigment, brown pigment, red pigment, purple pigment, blue pigment, green pigment, fluorescent pigment, metal powder pigment, others and polymer bonded dye. Specifically, utilized can be such as insoluble azo pigment, azo lake pigment, condensed azo pigment, chelate azo pigment, phthalocyanin type pigment, anthraquinone type pigment, perylene and perinone type pigment, thioindigo type pigment, quinacridone type pigment, dioxazine type pigment, isoindolinone type pigment, quinophthalone type pigment, dyeing lake pigment, azine pigment, nitroso pigment, nitro pigment, natural pigment, fluorescent pigment, inorganic pigment and carbon black.

The particle size of pigment is preferably in a range of 0.01-5 μm, more preferably in a range of 0.03-1 μm and specifically preferably in a range of 0.05-0.5 μm. It is not preferable with respect to stability of the dispersion in a sensitive layer coating solution when the particle size is less than 0.01 μm, while it is not preferable with respect to uniformity of a sensitive layer in the case of over 5 μm. As a method to disperse pigment, dispersion technologies well known in the art and utilized in manufacturing of such as ink and toner can be employed. A homogenizer includes such as an ultrasonic homogenizer, a sand mill, an atliter, a pearl mill, a super mill, a ball mill, an impeller, a disperser, a KD mill, a colloidal mill, a dynatron, a three-roll mill and a pressure kneader. The details are described in “Newest Pigment Application Technologies” (CMC Shuppan, 1986).

Pigment can be incorporated at a ratio of 0.01-10 weight % and preferably 0.1-5 weight %, against the total solid constituting the upper layer, with respect to sensitivity, uniformity and durability of a sensitive layer.

Further, to improve sensitivity, pigment can be added in the under layer. Since pigment, different from dye, has a small interaction with alkaline soluble resin, it is preferable that sensitivity can be improved without deterioration of development latitude even when being added in the under layer. As pigment types which can be incorporated in the under layer, pigment described above can be utilized. A pigment amount incorporated in the under layer is 0.1-50 weight % and preferably 1-20 weight %, based on a ratio against the total solid constituting the under layer, with respect to sensitivity and film physical properties.

(Acid-Decomposing Compound)

In this invention, an acid-decomposing compound (a compound decomposed by acid), preferably a compound provided with a bond which is decomposable by acid having at least one acetal or ketal group, is contained in the under layer. As a compound provided with at least one acetal or ketal group, compounds described in JP-A 2000-221676 are utilized, and other acid-decomposing compound can be also utilized. The compounds include such as a compound having a C—O—C bond described in JP-A Nos. 48-89003, 51-120714, 53-133429, 55-12995, 55-126236 and 56-17345; a compound having a Si—O—C bond described in JP-A Nos. 60-37549 and 60-121446; and other acid-decomposing compounds described in JP-A Nos. 60-3625 and 60-10247. Further, listed are a compound having a Si—N bond described in JP-A No. 62-222246; carbonic acid ester described in JP-A 62-251743; orthocarbonic acid ester described in JP-A 62-209451; orthotitanic acid ester described in JP-A 62-280841; orthosilicic acid ester described in JP-A 62-280842; a compound having a C-S bond described in JP-A 62-244038; and a compound such as phenolphthalein, cresolphthalein and phenolsulfophthalein being protected with a heat or acid-decomposing group, which is described in JP-A 2005-91802.

In this invention, a compound having at least one acetal or ketal group as an acid-decomposing compound is a compound represented by aforesaid Formula (1) or (2).

In aforesaid Formula (1), m1 is an integer of 1-4, and n1 is an integer of 2-30. Among compounds represented by Formula (1), a compound having ml of 1-2 and n1 of 5-15 is specifically preferable with respect to achieving the effect of sensitivity and/or depressed film thickness loss.

In aforesaid Formula (2), R, R₁ and R₂ are each a hydrogen atom, an alkyl group having a carbon number of 1-5, an alkoxy group having a carbon number of 1-5, a sulfo group, a carboxyl group or a hydroxyl group; p, q and r is an integer of 1-3; and m and n are an integer of 1-5. An alkyl group represented by R, R₁ and R₂ may be either straight chain or branched and includes a methyl group, an ethyl group, a propyl group, an isopropyl group, a butyl group, a tert-butyl group and a pentyl group; and an alkoxy group includes a methoxy group, an ethoxy group, a propoxy group, a butoxy group, a tert-butoxy group and a pentoxy group; and a sulfo group and a carboxyl group include salt thereof. Among compounds represented by Formula (2), compounds in which m and n are 1-4 are preferable to achieve the effects of sensitivity and/or depressed film thickness loss. Compounds represented by Formulas (1) and (2) can be synthesized by a method well known in the art.

An acid-decomposing compound may be utilized alone or in combination of at least two types.

(Acid Generating Agent)

In the under layer of this invention an acid generating agent is utilized. An acid generating agent is a compound capable of generating acid by light or heat, and includes various types of compounds and mixtures well known in the art.

For example, salt of such as BF₄⁻, PF₆⁻, SbF₆⁻, SiF₆²⁻ and CLO₄⁻ of diazonium, phosphonium, sulfonium and iodonium; organohalogen compound, orthoquinone-diazide sulfonium chloride and an organometallic/organohalogen compound can be also utilized as an acid generating agent of this invention. Further, listed are a compound to generate sulfonic acid by photodecomposition represented by iminosulfonate described in JP-A 4-365048, a disulfone compound described in JP-A 61-166544, o-naphthoquinone diazide-4-sulfonic acid halide described in JP-A 50-36209 (U.S. Pat. No. 3,969,118), and an o-naphthoquinone diazide compound described in JP-A 55-62444 (British Patent No. 2,038,801) or JP-B 1-11935. As other acid generating agents, cyclohexyl citrate; sulfonic acid alkyl ester such as p-acetoaminobenzene sulfonic acid cyclohexyl ester and p-bromobenzene sulfonic acid cyclohexyl ester; and alkylsulfonic acid ester can be utilized.

Examples of a compound to form the aforesaid hydrohalogenic acid includes those described in U.S. Pat. Nos. 3,515,552, 3,536,489 and 3,779,778, and German Patent Publication Open to Public Inspection No. 2,243,621, and a compound to generate acid by photodecomposition described in German Patent Publication Open to public Inspection No. 2,610,842 can be also utilized. Further, o-naphthoquinone diazide-4-sulfonic acid halogenide described in JP-A 50-36209 can be utilized.

In this invention, an organohalogen compound is a preferable photo-induced acid generating agent with respect to such as sensitivity in image formation by infrared ray exposure and storage stability in the case of being applied in an image forming material. Said organohalogen compound is preferably a triazines having a halogen substituted alkyl group and an oxadiazoles having a halogen substituted alkyl group, and specifically preferably s-triazines having a halogen substituted alkyl group. Examples of oxadiazoles having a halogen substituted alkyl group include a 2-halomethyl-1,3,4-oxadiazole type compound described in JP-A Nos. 54-74728, 55-24113, 55-77742, 60-3626 and 60-138539.

Among the above-described compounds which decompose and generate acid by irradiation of heat or radiation, those specifically preferably utilized will be shown below.

Oxazole derivatives represented by following Formula (PAG1) or s-triazine derivatives represented by Formula (PAG2), which is substituted by a trihalomethyl group.

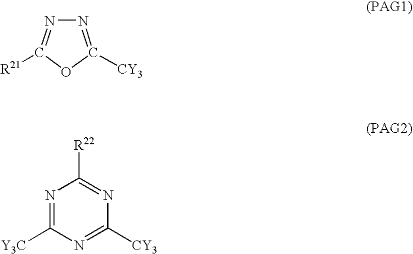

In the formula, R²¹ is a substituted or unsubstituted aryl group or alkenyl group; and R²² is a substituted or unsubstituted aryl group, alkyl group or —CY₃. Y is a chlorine atom or a bromine atom. Specifically, listed are the following compounds, however, this invention is not limited thereto.

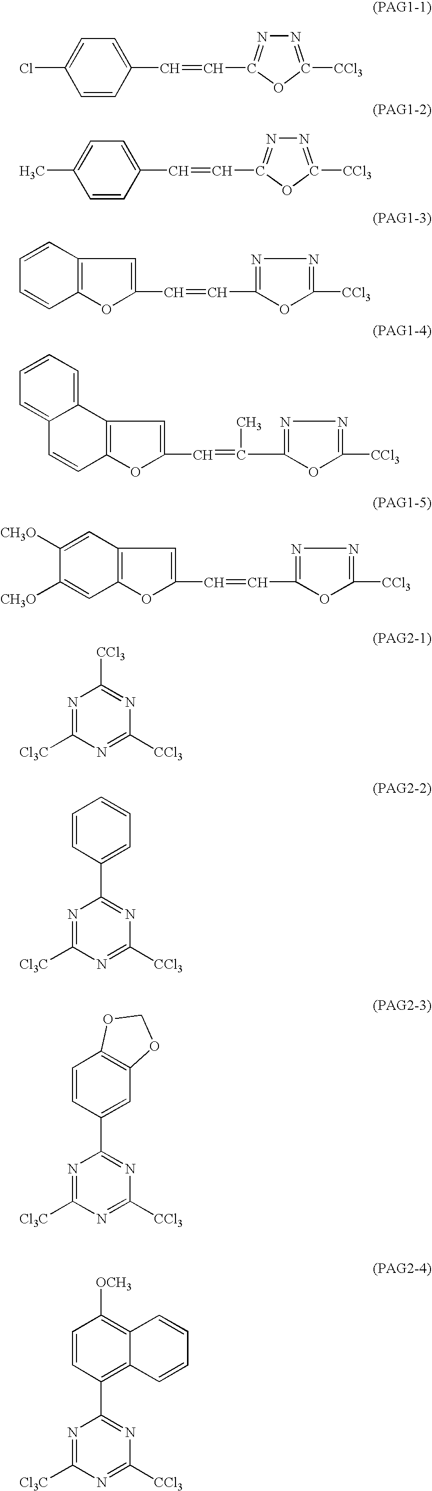

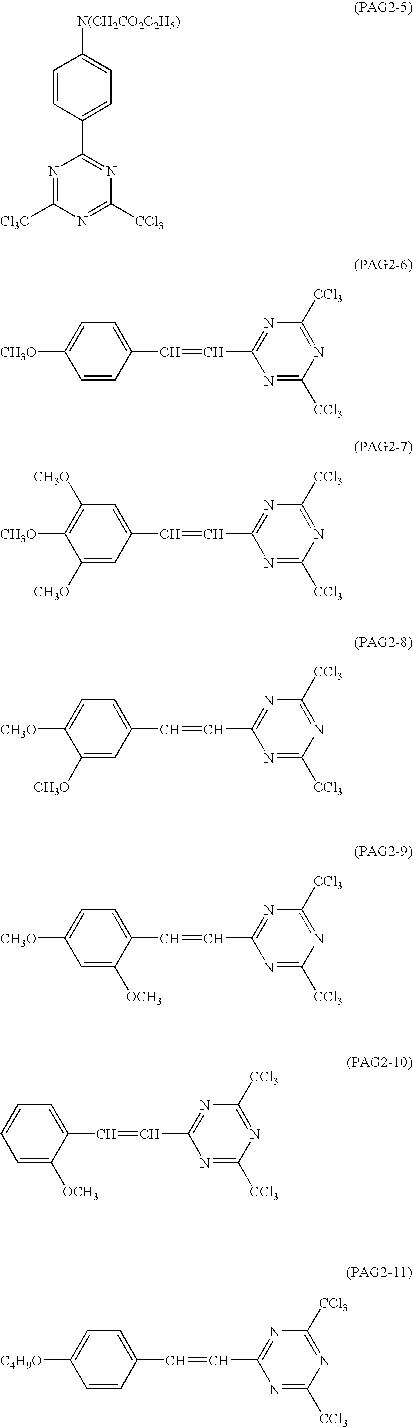

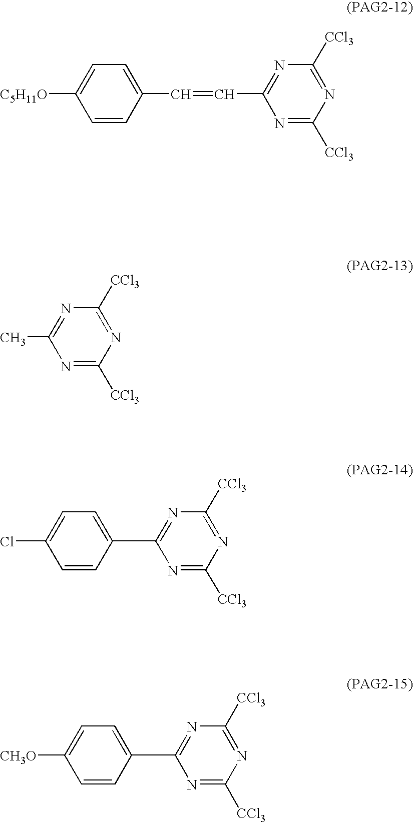

Iodonium sale represented by following Formula (PAG3) sulfonium salt represented by (PAG4) or diazonium salt.

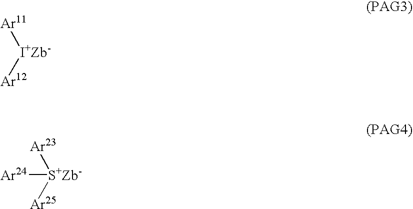

In the formula, Ar¹¹ and AR¹² each independently are a substituted or unsubstituted aryl group. A preferable substituent includes an alkyl group, a haloalkyl group, a cycloalkly group, an aryl group, an alkoxy group, a nitro group, a carboxyl group, an alkoxycarbonyl group, a hydroxyl group, a mercapto group and a halogen atom.

R³³, R³⁴ and R³⁵ each independently are a substituted or unsubstitued alkyl group or aryl group; and preferably an aryl group having a carbon number of 6-14, and an alkyl group having a carbon number of 1-8 and substituted derivatives thereof. A preferable substituent includes an alkoxy group having a carbon number of 1-8, an alkyl group having a carbon number of 1-8, a nitro group, a carboxyl group, a hydroxyl group and a halogen atom for an aryl group; and an alkoxy group having a carbon number of 1-8, a nitro group, a carboxyl group and an alkoxycarbonyl group for an alkyl group.

Further, two of R³³, R³⁴ and R³⁵, and Ar¹¹ and Ar¹² may bond via each single bond or a substituent.

Zb is a counter anion and includes, for example, perfluoroalkane sulfonic acid anion such as BF₆⁻, AsFG₆⁻, PF₆⁻, SbF₆⁻, SiF₆⁻, ClO₄⁻, CF₃SO₃⁻ and C₄F₉SO₃⁻; combined polycyclic aromatic sulfonic acid anion such as pentafluorobenzene sulfonic acid anion, naphthalene-1-sulfonic acid anion; anthraquinone sulfonic acid anion and sulfonic acid group containing dye, however, is not limited thereto.

Specific examples include the following compounds, however, are not limited thereto.

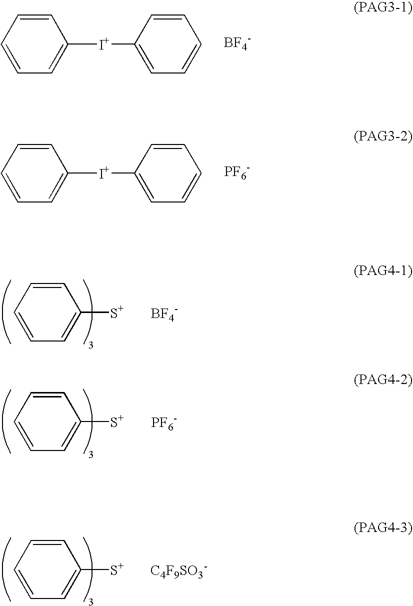

The above-described onium salt represented by (PAG3) and (Pag4) is well known in the art and can be synthesized by a method described in such as J. W. Knapczyk et al., J. Am. Chem. Soc., 91, 145 (1969); A. L. Maycok et al., J. Org. Chem., 35, 2532 (1970)l B. Goethas et al., Bull. Soc. Chem. Belg. 73, 546 (1964); H. M. Leicester, J. Am. Chem. Soc., 51, 3587 (1929)l J. V. Crivello t al., J. Polym. Chem. Ed., 18, 2677 (1980); U.S. Pat. Nos. 2,807,648 and 4,247,473; and JP-A 53-101331.

Disulfone derivatives represented by following Formula (PAG5) or iminosulfonate derivatives represented by following Formula (PAG6).

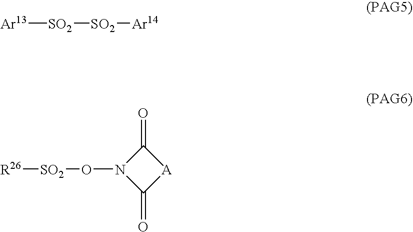

In the formula, Ar¹³ and Ar¹⁴ each independently are a substitued or ubsubstitued aryl group. R²⁶ is a substituted or ubsubstitued alkyl group or aryl group. A is a substituted or unsubtitued alkylene group, alkenylene group or arylene group.

Specific examples include the following compounds, however, are not limited thereto.

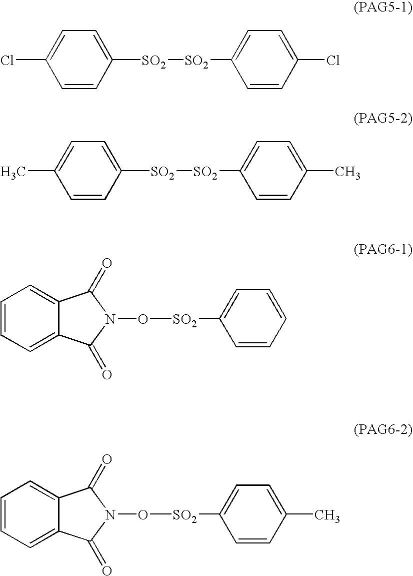

Further, in this invention, the following acid generating agents can be utilized. For example, a polymerization initiator described in JP-A 2005-70211, a compound capable of generating a radical described in Japanese Translation of PCT International Application Publication No. 2002-537419, and polymerization initiators described in JP-A Nos. 2001-175006, 2002-278057 and 2003-5363 cam be utilized, and in addition to these, such as onium salt having at least two cationic portions in one molecule described in JP-A 2003-76010, N-nitrosoamine type compounds of JP-A 2001-133966, compounds generating a radical by heat of JP-A 2001-343742, compounds generating acid or a radical by heat of JP-A 2002-6482, a borate compound of JP-A 2002-116539, compounds generating acid or a radical by heat of JP-A 2002-148790, a photo- or thermal-polymerization initiator having a polymerizing unsaturated group of JP-A 2002-207293, onium salt having an anion of not less than divalent as a counter ion of JP-A 2002-268217, a specific structure sulfonylsulfone compound of JP-A 2002-328465, and a compound generating a radical by heat of JP-A 2002-341519 can be appropriately utilized.

Among the above-described compounds, preferable is a compound represented by following Formula (3), and this compound is specifically preferable because of an excellent safelight safety characteristics.

R³¹—CX₂—(C═O)—R³² Formula (3)

In the formula, R³¹ is a hydrogen atom, a bromine atom, a chlorine atom, an alkyl group, an aryl group, an acyl group, an alkylsulfonyl group, an arylsulfonyl group, an iminosulfonyl group or a cyano group. R³² is a hydrogen atom or a monovalent organic substituent. R³¹ and R³² may form a ring by bonding to each other. X is a bromine atom or a chlorine atom.

Among compounds represented by Formula (3), one having R³¹ of a hydrogen atom or a chlorine atom are preferably utilized, with respect to sensitivity. Further, a monovalent organic substituent represented by R³² is not specifically limited provided that the compound represented by Formula (3) generates a radical by light, however, one having —R³² of —O—R³³ or —NR³⁴—R³³ (R³³ is a hydrogen atom or a monovalent organic substituent and R³⁴ is a hydrogen atom or an alkyl group) is preferably utilized. Further, in this case, one having R³¹¹ of a hydrogen atom, a bromine atom or a chlorine atom is also preferably utilized with respect to sensitivity.

Further, among these compounds, a compound having at least one acetyl group, which is selected from a tribromoacetyl group, a dibromoacetyl group, a trichloroacetyl group and a dichloroacetyl group, in a molecule is preferable. Further, with respect to synthesis, specifically preferable is a compound having at least one acetoxy group, which is selected from a tribromoacetoxy group, a dibromoacetoxy group, a trichloroacetoxy group and a dichloroacetoxy group, in a molecule and being prepared by a reaction of monohydric or polyhydric alcohol with a corresponding oxychloride compound; and a compound having at least one acetylamido group, which is selected from a tribromoacetylamido group, a dibromoacetylamido group, a trichloroacetylamido group and a dichloroacetylamido group, in a molecule and being prepared similarly by a reaction of monovalent or polyvalent primary amine with a corresponding oxychloride compound. Further, a compound having plural number of these acetyl group, acetoxy group and acetoamido group is also preferably utilized. These compounds can be easily synthesized under a condition of an ordinary reaction of esterification or amidation.

A typical synthesis method of a compound represented by Formula (3) is a reaction of esterification or amidation of derivatives of such as alcohol, phenol and amine by use of oxychloride such as tribromoacetyl chloride, dibromoacetyl chloride, trichloroacetyl chloride and dichloroacetyl chloride which correspond to each structure.

Alcohols, phenols and amines utilized in the above-described reaction are arbitrary, however, include monohydric alcohols such as ethanol, 2-butanol and 1-adamantanol; polyhydric alcohols such as diethylene glycol, trimethylolpropane and dipentaerythritol; phenols such as phenol, pyrogallol and naphthol; monovalent amines such as morphorine, aniline and 1-aminodecane; and polyvalent amines such as 2,2-dimethylpropylene diamine and 1,12-dodecane diamine.

Specific examples of a compound represented by Formula (3) include BR1- BR69 and CL1- CL50 which are described in paragraph Nos. 0038-0053 of JP-A 2005-70211.

Further in this invention, an acid generating agent may be polymer provided with a group capable of generating acid. By employing a polymer type as an acid generating agent, it is preferable because effects of alkaline soluble resin and acid generating agent can be functioned by one raw material. For example, by providing an acid generating group on the acrylic resin described above, not less than two types of effects such as chemical resistance owing to an acrylic resin and sensitivity and development latitude owing to an acid generating agent will be exhibited.

Polymer type acid generating agent is not specifically limited provided being polymer having a group capable of generating acid, however, preferable is polymer having at least one repeating unit of aliphatic monomer, which is represented by following Formulas (4) and (5), with respect compatibility among sensitivity, development latitude, chemical resistance and handling characteristics.

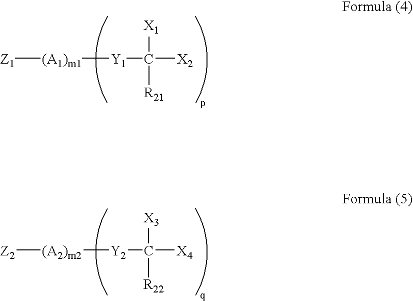

In Formula (4), X₁ and X₂ each independently are a halogen atom and R₂₁ is a hydrogen atom or a halogen atom. Y₁ is divalent connecting group; p is an integer of 1-3; A₁ is an alkylene group, a cycloalkylene group, an alkenylene group or an alkinylene group; m1is 0 or 1; and Z₁ is an ethylenic unsaturated group, an ethyleneimino group or an epoxy group.

In Formula (5), X₃ and X₄ each independently are a halogen atom and R₂₂ is a hydrogen atom, a halogen atom or a substituent. Y₂ is —OCO— or —NR₂₃CO— wherein R₂₃ is a hydrogen atom, a halogen atom or a substituent; and q is an integer of 1-3. A₂ is an aromatic group or a heterocyclic group; m is 0 or 1; and Z2 is an ethylenic unsaturated group, an ethyleneimino group or an epoxy group.

Specific examples of aliphatic monomer represented by Formulas (4) and (5) include 1-1-1-22 described in paragraph Nos. [0034] and [0035] and 2-1-2-15 described in paragraph Nos. [0043] and [0044], of JP-A 2003-91054.

Further, polymer having at least one repeating unit of aliphatic monomer represented by Formulas (4) and (5) can be copolymerized with monomer (a structural unit) which can be utilized in the above-described acrylic resin. A monomer ratio of a compound represented by aforesaid Formulas (4) and (5) in copolymer is preferably 1-80% and more preferably 3-50%. It is not preferable because an effect of an acid generating agent will be decreased when the ratio is less than 1%, while it becomes difficult with respect to polymerizing property when the ratio is over 80%. Polymer having a repeating unit derived from a compound represented by aforesaid Formulas (4) and (5) may be utilized alone or in combination of at least two types. Specifically preferable embodiment is to utilize an acid generating agent of a polymer type and an acid generating agent of a low molecular weight type in combination to make the effects of this invention compatible. Specific compounds include compounds of table 1 which is described in paragraph [0046π of JP-A 2003-91054.

The content of these acid generating agents is generally 0.1-30 weight % and more preferably 1-15 weight %, against the total composition solid in the upper layer. It is not preferable because improvement of development latitude is not large when the content is less than 1%. Further, it is not preferable because of deterioration of storage stability when the content is over 15%.

An acid generating agent may be utilized alone or in combination of not less than two types.

<Visualizing Agent>.

As a visualizing agent according to this invention, in addition to the aforesaid salt forming organic dye, other dye can be utilized. Preferable dye includes oil soluble dye and basic dye including salt forming organic dye. Those changing color by a reaction with a free radical or acid, are specifically preferably utilized. “To change color” includes any of a color change from colorless to colored and a change from colored to colorless or to a different color. Preferable dye is one which forms salt with acid to change the color.

For example, dye of a triphenyl methane type, a diphenyl methane type, an oxazine type, a xanthene type, an iminonaphthoquinone type, azomethine type or an anthraquinone type, represented by Victoria Pure Blue BOH (manufactured by Hodogaya Chemicals Co., Ltd.) Oil Blue-#603 (manufactured by Orient Chemical Industries Co., Ltd.), Patent Pure Blue (manufactured by Sumitomo Mikuni Chemistry Co., Ltd.), Crystal Violet, Brilliant Green, Ethyl Violet, Methyl Violet, Methyl Green, Erythrosine B, Basic Fuchsine, Malachite Green, Oil Red, m-Cresol Purple, Rhodamine B, Auramine, 4-p-diethylaminophenyl iminonaphthoquinone and cyano-p-diethylaminophenyl acetoanilide, are listed as examples of a color changing agent, which changes color from colored to colorless or to a different color.

On the other hand, a color changing agent which changes to colored from colorless includes leuco dye and primary or secondary arylamine type dye, represented by triphenylamine, diphenylamine, o-chloroaniline, 1,2,3-triphenylguanidine, naphthylamine, diaminophenylmethane, p,p′-bis-dimethylaminodiphenylamine, 1,2-dianilinoethylene, p,p′,p″-tris-dimethylaminotriphenylmethane, p,p′-bis-dimethylaminodiphenylmethylimine, p,p′,p″-triamino-o-methyltriphenylmethane, p,p′-bis-dimethylaminodiphenyl-4-anilinonaphthylmethane and p,p′,p″-triaminotriphenylmethane. These compounds may be utilized alone or in combination of not less than two types.

Herein, specifically preferable visualizing agents are Victoria Pure Blue BOH, Crystal Violet and Ethyl Violet.

These dyes can be added in a planographic printing plate material at a ratio of 0.01-10 weight % and preferably 0.1-3 weight % against the total solid of a composition.

(Development Accelerator)

In a planographic printing plate material of this invention, a compound having a low molecular weight acidic group may be appropriately incorporated for the purpose of improving solubility. An acidic group includes an acidic group having a pKa value of 7-11 such as a thiol group, a phenolic hydroxyl group, a sulfonamido group and an active methylene group. The addition amount is preferably 0.05-5 weight % and more preferably 0.1-3 weight % based on a ratio against the total solid of the composition. It is not preferable that there is a tendency to increase solubility of each layer against a developing solution when the ratio is over 5%.

(Development Restrainer)

In this invention, various types of solubility restrainer may be incorporated for the purpose of controlling solubility. As a solubility restrainer, a disulfone compound or a sulfone compound such as described in JP-A 11-11941 is suitably utilized and, as a specific example, 4,4′-bishydroxyphenylsulfone is preferably utilized. The addition amount is preferably 0.05-20 weight % and more preferably 0.5-10 weight %, based on a ratio in each composition.

Further, a development restrainer can be incorporated for the purpose of enhancing solubility restraining ability. A development restrainer according to this invention is not specifically limited provided forming an interaction with the aforesaid alkaline soluble resin to essentially decrease solubility of said alkaline soluble resin against a developing solution in the unexposed portion as well as decreasing said interaction in the exposed portion to make the resin soluble in a developing solution, however, specifically preferably utilized are such as quaternary ammonium salt and a polyethylene glycol type compound.

Quaternary ammonium salt is not specifically limited and includes tetraalkyl ammonium salt, trialkylaryl ammonium salt, dialkyldiaryl ammonium salt, alkyltriaryl ammonium salt, tetraaryl ammonium salt, cyclic ammonium salt and bicyclic ammonium salt. The addition amount of quaternary ammonium salt is preferably 0.1-50 weight % and more preferably 1-30 weight %, against the upper layer total solid. It is not preferable that a development restraining effect becomes small when the addition amount is less than 0.1 weight %, while it is not preferable that there may cause a bad effect on film forming ability of the aforesaid alkaline soluble resin in the case of addition of over 50 weight %.

Further, a polyethylene glycol compound is not specifically limited and includes those having a structure represented by following Formula (6).

R₃₁—{—O—(R₃₃—O—)ₘ₅—R₃₂}ₙ₆ Formula (6)

In above Formula (6), R₃₁ is a polyhydric alcohol residual group or a polyhydric phenol residual group; and R₃₂ is a hydrogen atom, an alkyl group, an alkenyl group, an alkynyl group, an alkyloyl group, an aryl group or an aryloyl group which may be provided with a substituent and has a carbon number of 1-25. R₃₃ is an alkylene group which may be provided with a substituent; m5 is an integer of not less than 10 as an average, and n5 is an integer of 1-4.

Examples of a polyethylene glycol compound represented by above-described Formula (6) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene glycol sorbitol esters, polypropylene glycol sorbitol esters, polyethylene glycol fatty acid esters, polypropylene glycol fatty acid esters, polyethylene glycolated ethylenediamines, polypropylene glycolated ethylenediamines, polyethylene glycolated diethylenetriamines and polypropylene glycolated diethylenetriamines. The addition amount of a polyethylene glycol type compound is preferably 0.1-50 weight % and more preferably 1-30 weight %, against the upper layer total solid. It is not preferable that the development restraining effect is small when the addition amount of less than 0.1%, while in the case of addition of over 50 weight %, a polyethylene glycol compound which cannot perform interaction with the aforesaid alkaline soluble resin may accelerate penetration of a developing solution to provide a bad effect on image forming property.

Further, sensitivity will decrease in the case of performing a procedure to enhance solubility restraining ability; however, addition of a lactone compound is effective to depress sensitivity decrease. It is considered that, in the exposed region, that is, when a developing solution penetrates into a recording layer of the region where inhibition is removed, a developing solution and a lactone compound react to newly generate a carboxylic acid compound, resulting in that this lactone compound improves sensitivity by accelerating dissolution of a recording layer in the exposed region.

<Sensitivity Improver>

In this invention, cyclic acid anhydrides, phenols and organic acids can be also utilized together for the purpose of improving sensitivity.

As cyclic acid anhydride, utilized can be such as phthalic acid anhydride, tetrahydrophthalic acid anhydride, hexahydrophthalic acid anhydride, 3,6-endooxy-Δ4-tetrahydrophthalic acid anhydride, tetrachlorophthalic acid anhydride, maleic acid anhydride, chloromaleic acid anhydride, α-phenylmaleic acid anhydride, succinic acid anhydride and pyromellitic acid anhydride, which are described in U.S. Pat. No. 4,115,128.

Phenols include such as bisphenol A, p-nitorophenol, p-ethoxyphenol, 2,4,4′-trihydroxybenzophnone, 2,3,4-trihydroxybenzophnone, 4-hydroxybenzophnone, 4,4′,4″-trihydroxytriphenylmethane and 4,4′,3″,4″-tetrahydroxy-3,5,3′,5-tetramethyltriphenylmethane.

Further, organic acids include such as sulfonic acids, sulfinic acids, alkylsulfuric acids, phosphonic acids, phosphoric acid esters and carboxylic acids described in JP-A 60-88942, and specifically include p-toluenesulfonic acid, dodecylbenzenesulfonic acid, naphthalenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluylic acid, 3,4-dimethoxybenzoic acid, phthalic acid, terephthalic acid, 4-cyclohexene-1,2-dicarboxylic acid, erucic acid, lauric acid, n-undecanoic acid and ascorbic acid. A ratio of the above-described cyclic acid anhydride, phenols and organic acids in a composition is preferably 0.05-20 weight %, more preferably 0.1-15 weight % and specifically preferably 0.1-10 weight %.

Further, an alcohol compounds, α-position of which is substituted by at least one trifluoromethyl group and is described in JP-A 2005-99298, can be also utilized. This compound increases an acidity of a hydroxyl group at α-position due to an electron attracting effect of a trifluoromethyl group, resulting in exhibiting an action to improve solubility against an alkaline developer solution.

<Base Decomposing Agent>

In this invention, a compound which decomposes by an action of base to newly generate a basic molecule may be incorporated. A compound which decomposes by an action of base to newly generate a basic molecule is a compound to generate base in the presence of base, preferably under a heated condition. The compound regenerates base by generated base. Therefore base generation proceeds in chain reaction wise. Such a compound is exemplified by compounds described in Proc. ACS. Polym. Mater. Sci. Eng., vol. 81, 93 (1999) and Angew. Chem. Int. Ed., vol. 39, 3245 (2000). Preferably listed are compounds represented by Formulas (I)-(IV) described in JP-A 2004-151138.

<Back Coating Layer>

A printing plate of this invention, after having been provided with an anodic oxidation film on the both surfaces, may be provided with a back coating layer on the back surface of a support to restrain dissolution of the anodic oxidation film of aluminum during a development process. It is preferable that development sludge is inhibited to prolong the developer solution life and to decrease the amount of a replenisher by providing a back coating layer. A preferable embodiment of a back coating layer is those containing (a) metal oxide prepared by hydrolysis and polycondensation of an organometallic compound or an inorganic metallic compound, (b) colloidal silica sol and (c) an organic polymer compound.

(a) Metal oxide utilized in a back coating layer includes such as silica (silicon oxide), titanium oxide, boron oxide, aluminum oxide and zirconium oxide and a complex compound thereof. Metal oxide in a back coating layer utilized in this invention can be prepared by coating and drying a so-called sol-gel reaction solution, comprising an organometallic compound or inorganic metallic compound, hydrolysis and polycondensation of which having been preformed in water and an organic solvent with a catalyst of acid or alkali, on the back a support. An organometallic compound or inorganic metallic compound utilized here includes, for example, metal alkoxide, metal acetylacetonate, metal acetate, metal oxalate, metal nitrate, metal sulfate, metal carbonate, metal oxychloride, metal chloride and a condensation compound prepared by partial hydrolysis and oligomerization thereof.

Metal alkoxyide is represented by Formula M(OR)ₙ (M is a metal element, R is an alkyl group and n is an oxidation number of the metal element). Examples include such as Si(OCH₃)₄, Si(OC₂H₅)₄, Si(OC₃H₇)₄, Si(OC₄H₉)₄, Al(OCH₃)₃, Al(OC₂H₅)₃, Al(OC₃H₇)₃, Al(OC₄H₉)₃, B(OCH₃)₃, B(OC₂H₅)₃, B(OC₃H₇)₃, B(OC₄H₉)₃, Ti(OCH₃)₄, Ti(OC₂H₅)₄, Ti(OC₃H₇)₄, Ti(OC₄H₉))₄, Zr(OCH₃)₄, Zr(OC₂H₅)₄, Zr(OC₃H₇)₄ and Zr(OC₄H₉)₄.

In addition to these, listed is alkoxide of such as Ge, Li, Na, Fe, Ga, Mg, P, Sb, Sn, Ta and V. Further, mono-substituted silicon alkoxide such as CH₃Si(OCH₃)₃, C₂H₅Si(OCH₃)₃, CH₃Si(OC₂H₅)₃ and C₂H₅Si(OC₂H₅)₃ is also utilized.

Examples of metal acetylacetonate include Al(COCH₂COCH₃)₃ and Ti(COCH₂COCH₃)₄.

Examples of metal oxalate include such as K₂TiO(C₂O₄)₂, and examples of metal nitrate include such as Al(NO₃)₃ and ZrO(NO₃)₂.2H₂O. Examples of metal sulfate include Al(SO₄)₃, (NH₄)Al(SO₄)₂, KA1(SO₄)₂ and NaAl(SO₄)₂; examples of metal oxychloride include Si₂OCl₆ and ZrOCl₂; and examples of chloride include such as AlCl , SiCl₃, ZrCl₂ and TiCl₄.

These organometallic compounds or inorganic metallic compounds can be utilized alone or in combination of not less than two types. Among these organometallic compounds or inorganic metallic compounds, metal alkoxide is preferred because the reactivity is high to easily form polymer comprising a metal-oxygen bond. Among them, alkoxy compounds of silicon such as Si(OCH₃)₄, Si(OC₂H₅)₄, Si(OC₃H₇)₄ and Si(OC₄H₉)₄ which are easily available at a low cost and a metal oxide cover layer prepared from which is excellent in resistance against a developer solution, are specifically preferable.

Further, oligomer prepared by partial hydrolysis and condensation of these alkoxy compounds of silicon is also preferable. Such an example includes ethylsilicate oligomer of heptamer as an average containing approximately 40 weight % of SiO₂.

Further, to incorporate a so-called silane coupling agent, in which one or two of alkoxy groups in the above-described tetraalkoxy compound are substituted by an alkyl group or a reactive group, in combination is also a preferable embodiment. A silane coupling agent utilized in this case includes such as vinyltrimethoxysilane, vinyltriethoxysilane, γ-(metharyloxypropyl)trimethoxysilane, β-(3,4-epoxycyclohexyl)ethyltrimethoxysilane, γ-glycidoxy propylmethyldiethoxysilane, N-β-(aminoethyl)γ-aminopropyltrimethoxysilane, N-β-(aminoethyl)γ-aminopropylmetyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, methyltrimethoxysilane and methyltriethoxysilane.

On the other hand, organic and inorganic acid as well as alkali are utilized as a catalyst. Examples thereof include inorganic acid such as hydrochloric acid, sulfuric acid, sulfurous acid, nitric acid, nitrous acid, hydrofluoric acid, phosphoric acid and phosphorous acid; organic acid such as formic acid, acetic acid, propionic acid, butyric acid, glycolic acid, chloroacetic acid, dichloroacetic acid, trichloroacetic acid, fluoroactic acid, bromoacetic acid, methoxyacetic acid, oxaloacetic acid, citric acid, oxalic acid, succinic acid, malic acid, tartaric acid, fumaric acid, maleic acid, malonic acid, ascorbic acid, benzoic acid, substituted benzoic acid such as 3,4-dimethoxybenzoic acid, phenoxyacetic acid, phthalic acid, picric acid, nicotinic acid, picolinic acid, pyridine, pyrazol, dipicolinic acid, adipic acid, p-toluylic acid, terephthalic acid, 1,4-cyclohexene-2,2-dicarboxylic acid, erucic acid, lauric acid and n-undecanoic acid; alkali such as hydroxide of alkaline metal and alkaline earth metal, ammonia, ethanolamine, diethanolamine and triethanolamine. In addition to these, organic acid such as sulfonic acids, sulfinic acids, alkylsulfuric acids, phosphonic acids and phosphoric acid esters; specifically, such as p-toluenesulfonic acid, dodecylbenzenesulfonic acid, p-toluenesulfinic acid, ethylic acid, phenylphophonic acid, phenylphosphinic acid, phenylphosphate and diphenylphosphate, can be utilized. These catalysts can be utilized alone or in combination of at least two types. The catalyst is added preferably in a range of 0.001-10 weight % and more preferably in a range of 0.05-5 weight %, against a metal compound as a raw material. The start of a sol-gel reaction will be delayed when a catalyst amount is less than this range, while a cover layer prepared is poor in developer resistance probably because a reaction proceeds rapidly to form inhomogeneous sol-gel particles when the addition amount is over this range.

To start a sol-gel reaction, a suitable amount of water is further required, and the preferable addition amount is 0.05-50 times mol and more preferably 0.5-30 times mol, of a required amount of water to completely hydrolyze a metal compound as a raw material. Hydrolysis hardly proceeds when the amount of water is less than this range, while the reaction also hardly proceeds when the amount of water is over this range possibly because a raw material is diluted. A sol-gel reaction solution is further added with a solvent. The solvent may be those provided dissolving a metal compound as a raw material and dissolving or dispersing sol-gel particles produced by the reaction, and low molecular weight alcohols such as methanol, ethanol, propanol and butanol; and ketones such as acetone, methyl ethyl ketone and diethyl ketone can be utilized. Further, for the purpose of improving coated surface quality of a back coating layer, mono- or di-alkyl ether and acetic acid ester of glycols such as ethylene glycol, diethylene glycol, triethylene glycol, propylene glycol and dipropylene glycol can be utilized. Among these solvents, lower alcohols which are miscible with water are preferable. A sol-gel reaction solution is adjusted with a solvent to make a suitable concentration for coating; however, the hydrolysis reaction hardly proceeds possibly due to dilution of a raw material when the whole amount of a solvent is added into a reaction solution.

Therefore, preferable is a method in which a part of a solvent is added into a sol-gel reaction solution, and then the residual solvent is added at the time when the reaction has proceeded.

The sol-gel reaction proceeds by mixing a metal oxide raw material, water, a solvent and a catalyst. Progress of the reaction depends on types thereof, a composition ratio and temperature and time of the reaction, and affects film quality after film formation. In particular, since an effect of reaction temperature is large, it is preferable to control temperature during the reaction. In a sol-gel reaction, in addition to the above-described essential components, a compound containing a hydroxyl group, an amino group or active hydrogen in a molecule may be incorporated to suitably control the sol-gel reaction. Such a compound includes polyethylene glycol, polypropylene glycol, block copolymer thereof, and monoalkyl ether or monoalkylaryl ether thereof; various type of phenols such as phenol and cresol; polyvinyl alcohol and copolymer thereof with other vinyl monomer, acid having a hydroxyl group such as malic acid and tartaric acid; aliphatic and aromatic amine; and formaldehyde and dimethylformaldehyde. Further, (c) an organic polymer compound is incorporated to improve affinity of the dried solid of a coating solution against organic solvent to be made soluble.

“(c) an organic polymer compound” in a back coating layer utilized in this invention includes such as polyvinyl chloride, polyvinyl alcohol, polyvinyl acetate, polyvinyl phenol, halogenated polyvinylphenol, polyvinyl formal, polyvinyl acetal, polyvinyl butyral, polyamide, polyurethane, polyurea, polyimide, polycarbonate, epoxy resin, phenol novolak or condensed resin of resolphenols with aldehyde, polyvinylidene chloride, polystyrene, silicone resin, active methylene, acrylic type copolymer having an alkaline soluble group such as a phenolic hydroxyl group, a sulfoneamido group and a carboxyl group, and binary or not less than ternary copolymer resin thereof. Specifically, listed are phenol novolak resin or resol resin, which includes condensed novolak resin or resol resin of such as phenol, cresol (m-cresol, p-cresol and m/p mixed cresol), phenol/cresol (m-cresol, p-cresol and m/p mixed cresol), phenol modified xylene, tert-butylphenol, octylphenol, resolcinol, pyrogallol, catecol, chlorophenol (m-Cl and p-Cl), bromophenol (m-Br and p-Br), salicylic acid and fluorogulcinol with formaldehyde, and condensed resin of the above-described phenols with acetone.

Other suitable polymer compounds include copolymer which is comprised of following (1)-(12) as a constitutive unit and has a molecular weight of generally 10,000-200,000.

(1) Acrylamides, methacrylamides, acrylic acid esters, methacrylic acid esters and hydroxystyrenes having an aromatic hydroxyl group, such as N-(4-hydroxyphenyl)acrylamide or N-(4-hydroxyphenyl)methacrylamide; and o-, m- and p-hydroxystyrene; o-, m- and p-hydroxyphenyl acrylate or methacrylate, (2) acrylic acid esters and methacrylic acid esters having an aliphatic hydroxyl group such as 2-hydroxyethyl acrylate or 2-hydroxyethyl methacrylate, (3) (substituted) acrylic acid esters such as methyl acrylate, ethyl acrylate, propyl acrylate, butyl acrylate, amyl acrylate, hexyl acrylate, cyclohexyl acrylate, octyl acrylate, phenyl acrylate, benzyl acrylate, 2-chloroethyl acrylate, 4-hydroxybutyl acrylate, glycidyl acrylate and N-dimethylaminoethyl acrylate, (4) (substituted) methacrylic acid esters such as methyl methacrylate, ethyl methacrylate, propyl methacrylate, butyl methacrylate, amyl methacrylate, hexyl methacrylate, cyclohexyl methacrylate, octyl methacrylate, phenyl methacrylate, benzyl methacrylate, 2-chloroethyl methacrylate, 4-hydroxybutyl methacrylate, glycidyl methacrylate and N-dimethylaminoethyl methacrylate, (5) acrylamide or methacrylamide such as acrylamide, methacrylamide, N-methylolacrylamide, N-methylolmethacrylamide, N-ethylacrylamide, N-ethylmethacrylamide, N-hexylacrylamide, N-hexylmethacrylamide, N-cyclohexylacrylamide, N-cyclohexylmethacrylamide, N-hydroxyethylacrylamide, N-hydroxyethylmethacrylamide, N-phenylacrylamide, N-phenylmethacrylamide, N-benzylacryamide, N-benzylmethacrylamide, N-nitrophenylacrylamide, N-nitrophenylmethacrylamide, N-ethyl-N-phenylacrylamide and N-ethyl-N-phenylmethacrylamide, (6) vinyl ethers such as ethyl vinyl ether, 2-chloroethyl vinyl ether, hydroxyethyl vinyl ether, propyl vinyl ether, butyl vinyl ether, octyl vinyl ether and phenyl vinyl ether, (7) vinyl esters such as vinyl acetate, vinyl chloroacetate, vinyl butyrate and vinyl benzoate, (8) styrenes such as styrene, methylstyrene and chloromethylstyrene, (9) vinyl ketones such as methyl vinyl ketone, ethyl vinyl ketone, propyl vinyl ketone and phenyl vinyl ketone, (10) olefins such as ethylene, propylene, isobutylene, butadiene and isoprene, (11) N-vinylpyrrolidone, N-vinylcarbazole, 4-vinylpyridine, acrylonitrile and methacrylonitrile, (12) acrylamides such as N-(o-aminosulfonylphenyl)acrylamide, N-(m-aminosulfonylphenyl)acrylamide, N-(p-aminosulfonylphenyl)acrylamide, N-[1-(3-aminosulfonyl)naphthyl]acrylamide and N-(2-aminosulfonylethyl)acrylamide; methacrylamides such as N-(o-aminosulfonylphenyl)methacrylamide, N-(m-aminosulfonylphenyl)methacrylamide, N-(p-aminosulfonylphenyl)methacrylamide, N-(1-(3-aminosulfonyl)naphthyl)methacrylamide and N-(2-aminosulfonylethyl)methacrylamide; sulfonamide acrylates such as o-aminosulfonylphenyl acrylate, m-aminosulfonylphenyl acrylate, p-aminosulfonylphenyl acrylate and 1-(3-aminosulfonylphenylnaphthyl)acrylate; sulfonamide methacrylates such as o-aminosulfonylphenyl methacrylate, m-aminosulfonylphenyl methacrylate, p-aminosulfonylphenyl acrylate and 1-(3-aminosulfonylphenylnaphthyl)methacrylate.

These are preferably provided with a weight average molecular weight of 500-20,000 and a number average molecular weight of 200-60,000, and the addition amount is specifically suitably 1-200 weight %, preferably 2-100 weight % and most preferably 5-50 weight %, against a metal compound as a raw material. The back coating layer will lose an essential function due to peeling off of the back coating layer by chemicals utilized during printing when the addition amount is over this range. Further, since hydrophilicity, which is essential to sol-gel, is deteriorated, it becomes very difficult to remove ink when a hydrophobic substance such as ink adheres on the back surface. (b) Colloidal silica sol in a back coating layer utilized in this invention includes a colloidal solution of ultra-micro-particles of silicic acid utilizing such as water, methanol, ethanol, isopropyl alcohol, butanol, xylene and dimethylformamide as a dispersion medium. Methanol dispersion medium is specifically preferred. The particle size of a dispersed phase is preferably 1-100 μm and specifically preferably 10-50 μm. In the case of over 100 μm, uniformity of coated film is deteriorated due to roughness of the surface. The content of silicic acid is preferably 5-80 wight %, and the hydrogen ion concentration specifically out of a neutral region (pH 6-8) is preferable with respect to stability. Specifically preferable is those in an acidic region. Further, silica sol can be utilized also in combination with other micro-particles such as alumina sol or lithium silicate. Thereby hardening property of sol-gel coated film is further improved. Specifically, the addition amount is not less than 30 weight % and not more than 300 weight %, more preferably 30-200 weight % and most preferably 50-100 weight % against a metal compound as a raw material. When the addition amount is over this range, it becomes difficult to perform uniform coating due to deteriorated film property. Further, when the addition amount is less than this range, adhesion of hydrophobic substances is easily caused, and there caused a problem of ink adhesion on the surface in the case that a printing plate, which has been subjected to PI mounting, is kept stacked.

<Coating and Drying>

The upper layer and the under layer of a planographic printing plate of this invention can be formed generally by dissolving the above-described each component in a solvent to be coated on a suitable support in order. As a solvent utilized here includes the following coating solvents. These solvents can be utilized alone or in combination.

(Coating Solvent)

For example, listed are n-propanol, isopropyl alcohol, n-butanol, sec-butanol, isobutanol, 2-methyl-1-butanol, 3-methyl-1-butanol, 2-methyl-2-butanol, 2-ethyl-1-butanol, 1-petanol, 2-pentanol, 3-pentanol, n-hexanol, 2-hexanol, cyclohexanol, methylcyclohexanol, 1-heptanol, 2-heptanol, 3-heptanol, 1-octanol, 4-methyl-2-pentanol, 2-hexyl alcohol, benzyl alcohol, ethylene glycol, diethylene glycol, triethylene glycol, tetraethylene glycol, 1,3-propane diol, 1,5-pentane glycol, dimethyltriglycol, furfuryl alcohol, hexylene glycol, hexyl ether, 3-methoxy-1-butanol, 3-methoxy-3-methylbutanol, butyl phenyl ether, ethylene glycol monoacetate, propylene glycol monomethyl ether, propylene glycol monoethyl ether, propylene glycol monopropyl ether, propylene glycol monobutyl ether, propylene glycol phenyl ether, dipropylene glycol monomethyl ether, dipropylene glycol monoethyl ether, dipropylene glycol monopropyl ether, dipropylene glycol monobutyl ether, tripropylene glycol monomethyl ether, methylcarbitol, ethylcarbitol acetate, butylcarbitol, triethylene glycol monomethyl ether, triethylene glycol monoethyl ether, tetraethylene glycol dimethyl ether, diacetone alcohol, acetophnone, cyclohexanone, methylcyclohexanone, acetonylacetone, isophorone, methyl lactate, ethyl lactate, butyl lactate, propylene carbonate phenyl acetate, sec-butyl acetate, cyclohexyl acetate, diethyl oxalate, methyl benzoate, ethyl benzoate, y-butyl lactone, 3-methoxy-1-butanol, 4-methoxy-1-butanol, 3-ethoxy-1-butanol, 3-methoxy-3-methyl-1-butanol, 3-methoxy-3-ethyl-1-pentanol, 4-ethoxy-1-pentanol, 5-methoxy-1-hexanol, 3-hydroxy-2-butanone, 4-hydroxy-2-butanone, 4-hydroxy-2-pentanone, 5-hydroxy-2-pentanone, 4-hydroxy-3-pentanone, 6-hydroxy-2-pentanone, 6-hydroxy-2-hexanone, 3-methyl-3-hydroxy-2-pentanone, methyl cellosolve (MC) and ethyl cellosolve (EC).

A solvent utilized in coating is preferably selected to have different solubility against alkaline soluble polymer utilized in the upper layer and alkaline soluble polymer utilized in the under layer. That is, at the time of coating a heat-sensitive layer as the upper layer adjacent to the under layer, after the under layer has been coated, when a solvent to dissolve an alkaline soluble polymer in the under layer is utilized as a coating solvent of an uppermost layer, mixing at the interface of the layers becomes not negligible, and in an extreme case, not a multilayer but a uniform single layer may be formed. In this way, when mixture at the interface of two layers adjacent to each other is caused or two layers become compatible each other to exhibit behavior like a uniform layer, the effect of this invention may be damaged by arranging two layers, which is not preferable. Therefore, a solvent utilized for coating of an upper heat-sensitive layer is preferably a poor solvent against an alkaline soluble polymer contained in the under layer.

To depress mixture at the interface of upper and under layers, a method to extremely rapidly dry the coated layers after the second layer has been coated, by blowing high pressure air through a slit nozzle approximately perpendicular to the transport direction of a web, by applying heat energy as conduction heat from the under surface of a web by use of a roll (a heat roll), into the interior of which heating medium such as vapor is supplied, or by a combination thereof can be employed.

As a method to make the interface partially compatible at a level that two layers sufficiently exhibit the effects of this invention, it is possible to control the degree in either of the above-described methods to utilize a difference of solvent solubility or to extremely rapidly dry a solvent after second layer having been coated.

The concentration of the above-described components (the total solid including additives) in a solvent at the time of coating each layer is preferably 1-50 weight %. Further, the coated amount (the solid) of a heat-sensitive layer on a support which is obtained after coating and drying differs depending on applications, however, is preferably 0.05-1.0 g/m² for the heat-sensitive layer and 0.3-3.0 g/m² for the under layer. There is a tendency to decrease image forming ability when a coated amount of the heat-sensitive layer is less than 0.05 g/m², while there causes a possibility of sensitivity decrease when it is over 1.0 g/m². Further, when a coated amount of the under layer is out of the above-described range, there is a tendency of decreasing an image forming ability. Further, the total of the aforesaid two layers is preferably 0.5-3.0 g/m², and there is a tendency to deteriorate film properties when a coated amount is less than 0.5 g/m², while to decrease sensitivity when it is over 3.0 g/m². In accordance with decrease of the coated amount, apparent sensitivity will be increased; however, film properties of a sensitive layer will be deteriorated.

A coating composition (an image forming layer coating solution) prepared is coated on a support by a method well known in the art, whereby a photo-polymerizing light-sensitive planographic printing plate material can be prepared. A coating method of a coating solution includes such as an air doctor coater method, a blade coater method, a wire bar method, a knife coater method, a dip coater method, a reverse roll coater method, a gravure coater method, a cast coating method, a curtain coater method and an extrusion coater method. Drying temperature of a light-sensitive layer is preferably in a range of 60-160° C., more preferably in a range of 80-140° C. and specifically preferably in a range of 90-120° C. Further, an infrared emission device may be arranged on a drying apparatus to improve drying efficiency.

In this invention, the aforesaid light-sensitive layer after having been coated on the aforesaid support and dried, an aging treatment may be performed to stabilize the abilities. An aging treatment may be performed either in continuous to a drying zone or separately from a drying zone. The above-described aging treatment may be utilized as a process to contact a compound having an OH group against the surface of the upper layer, which is described in JP-A 2005-17599. In an aging process, by penetrating and diffusing a compound having a polar group represented by water from the surface of a formed light-sensitive layer, an interactive property via water is improved in a light-sensitive layer as well as aggregation power is improved by heating, whereby characteristics of a light-sensitive layer can be improved. A temperature condition in an aging process is preferably set so that a certain amount of a compound to be diffused is evaporated, and a substance to be penetrated and diffused is represented by water, however, a compound provided having a polar group such as a hydroxyl group, a carboxyl group, a ketone group, an aldehyde group and an ester group, can be also suitably utilized. The compound is preferably provided with a boiling point of not higher than 200° C. and more preferably not higher than 150° C., or a boiling point of not lower than 50° C. and furthermore preferably of not lower than 70° C. The molecular weight is preferably not more than 150 and more preferably not more than 100.

The case of utilizing water as a substance to be penetrated into a light-sensitive layer will now be detailed. As a method to penetrate and diffuse water, a method to arrange the sample in a high humidity atmosphere is preferred, and as for a high humidity atmosphere, a treatment is performed in an atmosphere having an absolute humidity of generally not less than 0.007 kg/kg′ and preferably not less than 0.018 kg/kg′; and preferably not more than 0.5 kg/kg′ and furthermore preferably not more than 0.2 kg/kg′, for not less than 10 hours and more preferably for 16-32 hours. Treatment temperature is controlled to precisely adjust humidity, and is set to preferably not lower than 30° C. and more preferably not lower than 40° C.; further, preferably not higher than 100° C., more preferably not higher than 80° C. and specifically preferably not higher than 60° C. A residual solvent in a light-sensitive layer after having been subjected to an aging treatment is preferably not more than 8%, more preferably not more than 6% and most preferably not more than 5%. Further, it is preferably not less than 0.05% and more preferably not less than 0.2%

<Activator>

In this invention, to improve coating behavior or to increase stability of processing against development conditions, the upper and/or the under layer may be incorporated with nonionic surfactants such as described in JP-A Nos. 62-251740 and 3-208514, amphoteric surfactants such as described in JP-A Nos. 59-121044 and 4-13149, siloxane type compounds such as described in EP 950517, and copolymer of fluorine-containing monomer such as described in JP-A Nos. 62-170950, 11-288093 and 2003-57820.

Specific examples of a nonionic surfactant include such as sorbitan trisacetate, sorbitan monopalmitate, sorbitan trioleate, stealic acid monoglyceride and polyoxyethylene nonylphenyl ether. Specific examples of an amphoteric surfactant include such as alkyldi(aminoethyl)glycine, alkylpolyaminoethyl glycine hydrochloric salt, 2-alkyl-N-carboxyethyl-N-hydroxyethylimidazolium betaine and N-tetradecyl-N,N-betaine type (for example, a product name “Amorgen K”, manufactured by Daiichi Kogyo Co., Ltd.).

A siloxane compound is preferably block copolymer of dimethylsiloxane and polyalkylene oxide and specific examples include polyalkyleneoxide modified silicone such as DBE-224, DBE-621, DBE-712, DBP-732 and DBP-534, manufactured by Chisso Corp.; and Tego Glide 100 manufactured by Tego Corp., Germany. A ratio of the above-described nonionic surfactant and amphoteric surfactant against the total solid in the under layer or in the upper layer is preferably 0.1-15 weight %, more preferably 0.1-5.0 weight %, and still more preferably 0.5-3.0 weight %.

<Exposure and Development>

A planographic printing plate material prepared in the above manner is generally subjected to an image exposure and a development treatment to be utilized as a planographic printing plate. As a light source of light rays utilized for an image exposure, a light source having an emission wavelength in a near infrared to infrared region, and a solid laser and a semiconductor laser are specifically preferable. An image exposure is performed based on digital converted data with an infrared laser (830 nm) utilizing a CTP setter available on the market, being followed by a treatment such as development, whereby an image is formed on the surface of an aluminum support which can be supplied as a planographic printing plate.

An exposure apparatus utilized in this invention is not specifically limited provided being a laser beam type, and any one of an outer drum scanning type, an inner drum scanning type and a flat bed scanning type can be utilized; however, an exposure apparatus of an outer drum type equipped with a GLV modulator element is preferably employed which is easily operated in a multi-beam mode to increase productivity with an exposure of low luminance and long time.

In this invention, laser beam pixel retention time means time for a laser beam to pass one pixel (one dot), that is, exposure time per one pixel. In this invention, laser beam pixel retention time is set to 2.0-20 μsec and preferably 2.5-15 μsec. Further, a laser beam application amount in a time for a laser beam passes one pixel is preferably 10-300 mJ/cm² and more preferably 30-180 mJ/cm².

In an exposure process of this invention, to apply a multi-channel mode by use of a laser exposure recorder equipped with a GLV modulator element is preferable with respect to improving productivity of a planographic printing plate. As a GLV modulator element, preferable is one capable of dividing a laser beam into not less than 200 channels and more preferably not less than 500 channels. Further, a laser beam diameter is preferably not more than 15 μm and more preferably not more than 10 μm. A laser output is preferably 10-100 W and more preferably 20-80 W. A drum rotation speed is preferably 20-3,000 rpm and more preferably 30-2,000 rpm.

(Developer Solution)

A developer solution and a replenisher which are applicable to a planographic printing plate material of this invention have a pH in a range of 9.0-14.0 and preferably in a range of 12.0-13.5. For a developer solution (hereinafter, referred to as a developer solution also including a replenisher), an alkaline aqueous solution, which is well known in the art, can be utilized. For example, as base, sodium hydroxide, ammonium hydroxide, potassium hydroxide and lithium hydroxide are suitably utilized. These alkaline agents can be utilized alone or in combination of at least two types. In addition to these, listed are such as potassium silicate, sodium silicate, lithium silicate, ammonium silicate, potassium metasilicate, sodium metasilicate, lithium metasilicate, ammonium metasilicate, potassium phosphate, sodium phosphate, lithium phosphate, ammonium phosphate, potassium dihydrogenphosphate, sodium dihydrogenphosphate, lithium dihydrogenphosphate, ammonium dihydrogenphosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate and ammonium borate; and these may be incorporated as a salt form prepared in advance. Also in this case, sodium hydroxide, ammonium hydroxide, potassium hydroxide and lithium hydroxide can be added for pH adjustment. An organic alkaline agent such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ehtyleneimine, ethylenediamine and pyridine can be utilized in combination. Most preferable are potassium silicate and sodium silicate. The concentration of silicate is 2-4 weight % based on a SiO₂ converted concentration. Further, a mol ratio of SiO₂ to alkali metal M (SiO₂/M) is preferably in a range of 0.25-2.

Herein, a developer solution referred in this invention includes not only an unused solution utilized at the start of development but also a solution, having been replenished with a replenisher to correct and maintain the activity of a solution, which is lowered by a processing of an infrared laser light-sensitive planographic printing material (a so-called a running solution).

A developer solution and a replenisher of this invention can be appropriately added with various types of surfactants and organic solvents corresponding to purposes of acceleration of developability, dispersion of development scum and increase of affinity for ink in the image portion of a printing plate. A preferable surfactant includes anionic type, cationic type, nonionic type and amphoteric surfactants. Preferable examples of a surfactant include nonionic surfactants such as polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol mono-fatty acid esters, saccharose fatty acid partial esters, polyoxyethylene sorbitane fatty acid partial esters, polyoxyethylene sorbitol fatty acid partial esters, polyethylene glycol fatty acid esters, polyglycerin fatty acid partial esters, polyoxyethylenized caster oils, polyoxyethylene glycerin fatty acid partial esters, polyoxyethylene-polyoxypropylene block copolymer, polyoxyethylene-polyoxypropylene block copolymer adduct of ethylenediamine, fatty acid diethanolamides, N,N-bis-hydroxyalkylamines, polyoxyethylene alkylamine, triethanolamine fatty acid ester and trialkylamineoxide; an anionic surfacatant such as fatty acid salts, abietic acid salts, hydroxyalkanesulfonic acid salts, alkanesulfonic acid salts, dialkylsulfosuccinic acid ester salts, straight chain alkylbenzenesulfonic acid salts, branched alkylbenzenesulfonic acid salts, alkylnaphthalenesulfonic acid salts, alkyldiphenylethersulfonic acid salts, alkylphenoxypolyoxyethylene propylsulfonic acid salts, polyoxyethylene alkylsulfophenyl ether salts, N-methyl-N-oleyltaurine sodium salt, N-alkylsulfosuccinic acid monoamide disodium salt, petroleum sulfonic acid salts, sulfuric acidified beef tallow oil, sulfuric acid esters of fatty acid alkylester salts, alkylsulfuric acid ester salts, polyoxyethylene alkylether sulfuric acid ester salts, fatty acid monoglyceride sulfuric cacid ester salts, polyoxyethylene alkylphenyl ether sulfuric acid ester salts, polyoxyethylene styrylphenyl ether sulfuric acid ester salts, alkylphosphoric acid ester salts, polyoxyethylene alkyl ether phosphoric acid ester salts, polyoxyethylene alkylphenyl ether phosphoric acid ester salts, partial saponificated substances of styrene/maleic acid anhydride copolymer, partial saponification products of olefin/maleic acid anhydride copolymer and naphthalenesulfonic acid salt formalin condensed products; cationic surfactants such as alkylamines, quaternary ammonium salts such as tetrabutylammonium bromide, polyoxyethylene alkylamine salts, polyethylene polyamine derivatives; amphoteric surfactants such as carboxybetaines, aminocarboxylic acids, sulfobetaines, aminosulfuric acid esters and imidazolines. Among the above-described each surfactant, polyoxyethylene can be read also as polyoxyalkylene such as polyoxymethylene, polyoxypropylene and polyoxybutylene, and surfactants thereof are also included. A further preferable surfactant is a surfactant of a fluorine type which contains a perfluoroalkyl group in a molecule. Such a fluorine type surfactant includes, for example, an anionic type such as perfluorocarboxylic acid salts, perfluoroalkylsulfonic acid salts, perfluoroalkylsulfonic acid salts, perfluoroalkylphosphoric acid ester; an amphoteric type such as perfluoroalkylbetaine; a cationic type such as perfluoroalkyltrimethylammonium salt; and a noionic type such as perfluoroalkylamine oxide, perfluoroalkylethylene oxide adducts, oligomer containing a perfluoroalkyl group and a hydrophilic group, oligomer containing a perfluoroalkyl group and a hydrophobic group, oligomer containing a perfluoroalkyl group, a hydrophilic group and a hydrophobic group and urethane containing a perfluoroalkyl group and a hydrophobic group. The above-described surfactants can be utilized alone or in combination of at least two types, and added into a developer solution in a range of 0.001-10 weight % and more preferably in a range of 0.01-5 weight %.

In a developer solution and a replenisher of this invention, various types of development stabilizers can be utilized. Preferable examples thereof include a polyethylene glycol adduct of sugar alcohol, tetraalkylammonium salt such as tetraammoniumhydroxide, phosphonium salt such as tetrabutylphosphonium bromide and iodonium salt such as diphenyliodonium chloride, which are described in JP-A 6-282079. Further, listed are, an anionic surfactant or an amphoteric surfactant described in JP-A 50-51324, a water-soluble cationic polymer described in JP-A 55-95946, and a water-soluble amphoteric polymer electrolyte described in JP-A 56-142528. Further, listed are an organoborone compound added with alkylene glycol described in JP-A 59-84241, a water-soluble surfactant of a polyoxyethylene-polyoxypropylene block polymer type described in JP-A 60-111246, an alkylenediamine compound substituted by polyoxyethylene-polyoxypropylene described in JP-A 60-129750, polyethylene glycol having a weight average molecular weight of not less than 300 described in JP-A 61-215554, a fluorine-containing surfactant having a cationic group described in JP-A 63-175858, and a water-soluble ethylene oxide adduct and a water-soluble polyalkylene compound which are prepared by addition of not less than 4 moles of ethylene oxide to acid or alcohol, described in JP-A 2-39157.

An organic solvent is further appropriately utilized in a developer solution and a replenisher. An organic solvent utilizable in this invention is preferably those having solubility against water of not more than 10 weight % and preferably selected from those having a solubility of not more than 5 weight %. For example, listed are 1-phenylethanol, 2-phenylethanol, 3-phenyl-1-propanol, 4-phenyl-1-butanol, 4-phenyl-2-butanol, 2-phenyl-1-butanol, 2-phenoxyethanol, 2-benzyloxyethanol, o-methoxybenzylalcohol, m-methoxybenzylalcohol, p-methoxybenzylalcohol, bezylalcohol, cyclohexanol, 2-methylcyclohexanol, 3-methylcyclohexanol, 4-methylcyclohexanol, N-phenylethanolamine and N-phnyldiethanolamine. Herein, the content of an organic solvent is 0.1-5 weight % against the total weight of a utilized solution, however, it is preferable to contain substantially no organic solvent and specifically preferably to contain no organic solvent at all. Herein, substantially no organic solvent means an organic solvent content of not more than 1 weight %.

A developer solution and a replenisher of this invention can be further appropriately added with an organic carboxylic acid. Preferable carboxylic acid is aliphatic carboxylic acid and aromatic carboxylic acid, which have a carbon number of 6-20. Specific examples of aliphatic carboxylic acid include caproic acid, enanthylic acid, caprylic acid, lauric acid, myristic acid, palmitic acid and stearic acid, and specifically preferable is an alkane acid having a carbon number of 8-12. Further, either an unsaturated fatty acid provided with a double bond in a carbon chain or one having a branched carbon chain is also utilized. An aromatic carboxylic acid is a compound in which a carboxyl group is substituted by such as a benzene ring, a naphthalene ring and an anthracene ring; and specifically includes such as o-chlorobenzoic acid, p-chlorobenzoic acid, o-hydroxybenzoic acid; and specifically o-chlorobenzoic acid, p-chlorobenzoic acid, o-hydroxybenzoic acid, p-hydroxybenzoic acid, o-aminobenzoic acid, 2,4-dihydroxybenzoic acid, 2,5-dihydroxybenzoic acid, 2,6-dihydroxybenzoic acid, 2,3-dihydroxybenzoic acid, 3,5-dihydroxybenzoic acid, gallic acid, 1-hydroxy-2-naphthoic acid, 3-hydroxy-2-naphthoic acid, 2-hydroxy-1-naphthoic acid, 1-naphthoic acid and 2-naphthoic acid; however, hydroxynaphthoic acid is specifically effective. The above-described aliphatic acid and aromatic carboxylic acid are preferably utilized as sodium salt, potassium salt or ammonium salt to increase water-solubility. The content of an organic carboxylic acid in a developer solution utilized in this invention is not specifically limited; however, it is not sufficient at less than 0.1 weight %, while further improvement is not expected and dissolution of other additives utilized in combination may be disturbed at over 10 weight %. Therefore, a preferable addition amount is 0.1-10 weight % and more preferably 0.5-4 weight %, against a running developer solution.

A developer solution and a replenisher of this invention can be added with the following additives in addition to the aforesaid additives to enhance developability, and for example, listed are neutral salt such as NaCl, KCl and KBr described in JP-A 58-75152; a complex such as [Co(NH₃)]₆Cl₃ described in JP-A 59-121336; an amphoteric surfactant such as copolymer of vinylbenzyltrimethyl ammoniumchloride and sodium acrylate described in JP-A 56-142258; an organometallic surfactant containing such as Si and Ti described in JP-A 59-75255; and an organoboron compound described in JP-A 59-84241.

A developer solution and a replenisher of this invention can be further appropriately incorporated with an antiseptic agent, a colorant, a viscosity increasing agent, a defoaming agent and a water softener. A defoaming agent includes such as mineral oil, vegetable oil, alcohol, a surfactant and silicone, described in JP-A 2-24143. A water softener includes such as polyphosphoric acid and sodium, potassium and ammonium salt thereof; aminocarboxylic acid such as ethylenediaminetetraacetic acid, diethylenetriaminepentaacetic acid, triethylenetetraminehexaacetic acid, hydroxyethylethylenediaminetriacetic acid, nitrilotriacetic acid, 1,2-diaminocyclohexanetetraacetic acid and 1,3-diamino-2-propanoltetraacetic acid, and sodium, potassium and ammonium salt thereof; aminotri(methylenephophoricacid), ethylenediaminetetra(methylenephosphonic acid), diethylenetriaminepenta(methylenephophoric acid), triethylenetetraminehexa(methylenephosphonic acid), hydroxyethylethylenediaminetri(methylenephophoric acid) and 1-hydroxyethane-1,1-diphosphoric acid, and sodium, potassium and ammonium salt thereof. The best using amount of such a water softener varies depending on chelating power thereof and hardness of hard water and an amount of hard water utilized, however, the using amount is generally 0.01-5 weigh % and more preferably 0.01-0.5 weight % against a running developer solution. The aimed object cannot be sufficiently achieved at an addition amount less than this range, while color loss and an unfavorable effect on the image portion will be caused in the case of over this range. The residual component in a developer solution and a replenisher is water.

Further, it is advantageous, with respect to transportation, that a developer solution and a replenisher of this invention is prepared as a concentrated solution having a water content smaller than that of a running solution, which will be diluted with water at the time of running application. In this case, the degree of concentration not to cause separation or precipitation of each component is suitable; however, it is preferable to appropriately incorporate a solubilizer. As a solubilizer, a so-called hydrotrope agent such as toluenesulfonic acid, xylenesulfonic acid and alkali metal salt thereof, described in JP-A 6-32081 is preferably utilized.

(Non-silicate Developer Solution)

To apply a developer solution for a planographic printing plate material of this invention, a so-called “non-silicate developer”, which contains no alkali silicate but contains non-reducing sugar and base, can be also utilized. By performing development processing of a planographic printing plate material by use of this developer solution, it is possible to avoid deterioration of the surface of a recording layer as well as to maintain a state of excellent ink adhesion of a recording layer. Further, a planographic printing plate material generally exhibits narrow development latitude and a large variation of such as a line width depending on pH of a developer solution; however, a non-silicate developer solution is advantageous, compared to the case of employing a developer solution containing silicate, since it contains non-reducing sugar having buffering action to depress pH variation. Further, since non-reducing sugar is hardly contaminates a conductivity sensor and a pH sensor for control of solution activity compared to silicate, a non-silicate developer solution is advantageous also with respect to this point. Further, a non-silicate developer solution exhibits a significant improvement effect of discrimination.

The aforesaid non-reducing sugar is sugars provided with no isolated aldehyde groups nor ketone groups and not to exhibit reducing ability, which are classified into trehalose type sugars in which reducing groups bond to each other, glycoside in which a reducing group of sugars and non-sugars bond, and sugar alcohol which is sugars being hydrogenated and reduced; and any one can be preferably utilized in this invention. Herein, in this invention, non-reducing sugar described in JP-A 8-305039 can be preferably utilized.

These non-reducing sugars may be utilized alone or in combination of at least two types. The content of the aforesaid non-reducing sugar in the aforesaid non-silicate developer solution is preferably 0.1-30 weight % and more preferably 1-20 weight %, in view of promotion of high concentration and availability.

(Processing Method)

In preparation of a pranographic printing plate according to this invention, an automatic processor is preferably utilized. An automatic processor utilized in this invention is preferably equipped with a mechanism to automatically replenish a necessary amount of a replenisher into a development bath; preferably equipped with a mechanism to drain out a developer solution exceeding a predetermined amount; preferably equipped with a mechanism to automatically replenish a required amount of water into a development bath; preferably equipped with a mechanism to detect plate passage; preferably equipped with a mechanism to estimate the processing area of a plate based on detection of plate passage; preferably equipped with a mechanism to control a replenishing amount and/or a replenishing timing of a replenisher and/or water based on detection of plate passage and/or estimation of the processing area; preferably equipped with a mechanism to control temperature of a developer solution; preferably equipped with a mechanism to detect pH and/or conductivity, of a developer solution; preferably equipped with a mechanism to control a replenishing amount and/or a replenishing timing of a replenisher and/or water, based on pH and/or conductivity, of a developer solution.

An automatic processor utilized in this invention may be also provided with a pre-processing section to immerse a plate into a pre-processing solution prior to a development process. This pre-processing section is preferably equipped with a mechanism to spray a pre-processing solution onto the plate surface, preferably equipped with a mechanism to control temperature of a pre-processing solution at an arbitrary temperature in a range of 25-55° C., and preferably equipped with a mechanism to scrub the plate surface with a roller-shaped brush. Further, as this pre-processing solution, such as water is utilized.

An infrared laser heat-sensitive planographic printing plate material having been processed with a developer solution comprising the above-described composition is subjected to a post-treatment with washing water, a rinsing solution containing such as a surfactant, a finisher or a protective gum solution comprising such as gum arabi and a starch derivative as a primary component. In a post-processing of an infrared laser heat-sensitive planographic printing plate material according to this invention, these processes can be utilized in various combinations, and, for example, “development-washing→surfactant containing rinse solution processing” or “development→washing→processing with a finisher solution” are preferable because of small exhaustion of a rinsing solution or a finisher solution. Further, a multi-step counter-flow processing utilizing a rinse solution and a finisher solution is also a preferable embodiment. These post-processes are generally performed by use of an automatic processor constituted of a development section and a post-development section. To supply a post-processing solution, employed is a method to spray the solution through a spray nozzle or a method to immersing transfer a plate material through a processing bath filled with a processing solution. Further, it is also known a method to supply a small amount of washing water on the plate surface after development for washing, then to reuse the waste solution as dilution water for an original development solution. In such an automatic processing, processing can be performed while replenishing a replenisher depending on such as a processing amount and operation time of each processing solution. Further, a so-called a throw-away processing method, in which processing is performed with an essentially unused post-processing solution, can be also employed. An infrared laser heat-sensitive pranographic printing plate material prepared by the above processing is mounted on an off-set printer and utilized for printing of many sheets.

(Erasing)

In this invention, in the case of an unnecessary image portion (such as a film edge mark of original film) is present on a planographic printing plate having been prepared by image exposure, development, washing and/or rinsing and/or gumming; erasing of the unnecessary potion is performed. Such erasing is preferably performed by a method in which an erasing solution, such as those described in JP-B 2-13293, JP-A Nos. 10-186679, 2003-122026 and 2005-221961, is coated on the unnecessary image portion to be left for a predetermined time as it is, being followed by washing. Further, a method, in which actinic rays guided by an optical fiber are irradiated on the unnecessary image portion followed by development, as described in JP-A 59-174842, can be also employed.

(Burning Process)

In the case of intending to prepare a printing plate having further higher printing durability, the plate is appropriately subjected to a burning treatment.

In the case of burning a planographic printing plate, the plate is preferably treated by a surface fixing solution such as described in JP-B Nos. 61-2518 and 55-28062, JP-A Nos. 62-31859 and 61-159655.

As for the method, applied is a method to coat, on a planographic plate surface, a surface fixing solution with sponge or absorbent cotton soaked with said surface fixing solution, or to coat the solution by immersing a plate in a vat filled with a surface fixing solution, or to perform coating with an automatic coater. Further, to make the coated amount uniform by a squeezer or a squeezer roller after coating gives a more preferable result.

The suitable coating amount of a surface fixing solution is generally 0.03-0.8 g/m² (based on a dried weight). A plate coated with a surface fixing solution, after having been appropriately dried, is heated at high temperature by such as a burning processor (such as burning processor “BP-1300”, available from Fuji Photo Film Co., Ltd.). Heating temperature and time in this case, although they depend on a type of a component constituting an image, are preferably at a range of 180-300° C. and for a range of 1-20 minutes.

A planographic printing plate, having been subjected to a burning treatment, can be appropriately subjected to a treatment such as washing and gumming, which is conventionally performed, however, a desensitization treatment such as gumming can be omitted in the case of utilizing a surface fixing solution containing such as a water soluble polymer compound. A planographic printing plate prepared by such processes is mounted on such as a printer and utilized for printing of many sheets.

<Package Material>

(Interleaf)

A planographic printing plate material of this invention is preferably kept, stored and transported by inserting interleaves between planographic printing plate materials to prevent mechanical shock during storage or to reduce unnecessary shock during transportation. As for an interleaf, various types of interleaves can be utilized by appropriate selection.

For an interleaf, generally, a low cost raw material is often selected to restrain a material cost, and utilized can be such as paper utilizing 100% of wood pulp, paper utilizing synthetic pulp mixed together with wood pulp, and paper the surface thereof is provided with a low density or high density polyethylene layer. Particularly, paper without using synthetic pulp or a polyethylene layer can prepare an interleaf at a low cost because of a low material cost.

Among specifications of the interleaves described above, a preferable specification is a basis weight of 30-60 g/m², a smoothness of 10-100 second based on Beck's smoothness measurement method defined in JIS 8119, a moisture content of 4-8% based on a water content measurement method defined in JIS 8127, and a density of 0.7-0.9 g/cm³. Further, to absorb a residual solvent, preferable are those at least the surface to contact with a light-sensitive layer of which is not laminated with such as polymer.

<Printing>

Printing can be carried out by use of an ordinary planographic printer.

In recent years, also in a printing industry field, environmental preservation is exclaimed, and ink not using a petroleum type volatile organic solvent has been developed and the popularization thereof is in progress, and the effects of this invention is significant in the case of utilizing such printing ink to meet environmental preservation. Printing ink to meet environmental preservation includes such as soy bean ink “Naturalith 100” manufactured by Dainippon Ink & Chemicals Inc., VOC Zero Ink “TK Higheco NV” manufactured by Toyo Ink Mfg. Co., Ltd. and Process Ink “Soycelvo” manufactured by Tokyo Printing Ink Mfg. Co., Ltd.

### EXAMPLES

In the following, this invention will be detailed referring to examples; however, is not limited thereto.

### Example 1

<Preparation of Support>

An aluminum plate having a thickness of 0.24 mm (material 1050, refining H16), after having been immersed in a 5 weight % sodium hydroxide aqueous solution at 50° C. and subjected to a dissolution treatment to make a dissolution amount of 2 g/m² followed by washing, was immersed in a 10 weight % nitric acid aqueous solution at 25° C. for 30 seconds to be neutralized and then subjected to post-washing. Then this aluminum plate was subjected to an electrolytic roughening treatment by use of an electrolyte containing hydrochloric acid of 10 g/L and aluminum of 0.5 g/L employing alternate current of a sine wave under a condition of a current density of 60 A/dm².

At this time, the distance between an electrode and the sample surface was set to 10 mm. Electrolytic roughening treatment was carried out by dividing into 12 times and quantity of electricity (at the anode) of one time of the treatment was set to 80 C/dm² to make the total quantity of treatment electricity (at the anode) of 960 C/dm². Further, 1 second of an intermission time was provided between roughening treatments of each time.

The plate, after electrolytic roughening, was etched so as to make a dissolution amount including smut of 1.2 g/m² by being immersed in a phosphoric acid aqueous solution of 10 weight % kept at 50° C., followed by washing. Next, the plate was subjected to anodic oxidation treatment in a 20% sulfuric acid aqueous solution so as to make quantity of electricity of 250 C/dm² under a constant voltage condition, and was further washed. Then, after the surface water after washing had been squeezed, the plate was immersed in soda trisilicate aqueous solution of 2 weight % for 30 seconds, followed by washing, being immersed in polyphosphonic acid of 0.4 weight % at 60° C. for 30 seconds, and followed by being washed. The plate, the surface of which had been squeezed, was subjected to a heat treatment at 130° C. for 50 seconds to prepare a support.

A mean roughness of a support was measured by use of SE1700α (Kosaka Laboratory Co., Ltd.) to be 0.55 μm. A cell size of a support was observed by use of a SEM at a magnification of 100,000 times to be 40 nm. The layer thickness of polyvinylphosphonic acid was 0.01 μ.

<Preparation of Planographic Printing Plate Material Sample 1>

On the above-described support which had been surface treated, the under layer coating solution having the following composition was coated with a wire bar so as to make a dry coating amount of 1.0 g/m² and dried at 120° C. for 1.0 minute. Then the upper layer coating solution having the following composition was coated with a wire bar so as to make a dry coating amount of 0.4 g/m² and dried at 120° C. for 1.5 minutes. Further, the resulting planographic printing plate material, after having been cut into a size of 670 mm×560 mm, was stacked to 200 sheets by sandwiching the following interleaf P. In this state, an aging treatment under a condition of 45° C. and an absolute humidity of 0.037 kg/kg for 24 hours was performed, whereby planographic printing plate material sample 1 was prepared.

(Interleaf P)

Bleached craft pulp was ground, and paper material diluted to a concentration of 4 weight % was added with 0.4 weight % of a rosin type sizing agent, followed by being added with aluminum sulfate to make pH=5. This paper material was added with 5.0 weight % of a paper strength agent comprising starch as a primary component, followed by paper making to prepare interleaf P of 40 g/m2 having a moisture content of 5 weight %.

(Under Layer Coating Solution)

| | | |
|---|---|---|
| Acrylic resin 1 | 78.0 | weight parts |
| Acid-decomposing compound A | 1.0 | weight part |
| Acid-decomposing compound B | 5.0 | weight parts |
| Acid generating agent BR1 (Example compound BR22 of JP-A | 2.0 | weight parts |
| 2005-221715) | | |
| 2-methoxy-4-aminophenyldiazonium hexafluorophosphate | 1.2 | weight parts |
| Infrared absorption dye (Dye 1) | 6.0 | weigh parts |
| Fuluorine type surfactant; Megafac F-178K (manufactured | 0.8 | weigh parts |
| by Dainippon Ink & Chemicals Inc.) | | |
| Solvent: γ-butyrolactone/methyl ethyl ketone/1-methoxy- | 908.9 | weight parts |
| 2-propanol (1/2/1) | | |

(Upper Layer Coating Solution)

| | | |
|---|---|---|
| Reaction Resin A of intermediate 1 and novolak resin 1 | 75.0 | weigh parts |
| (m/p = 7/3, molecular weight of 4,000) | | |
| Acrylic resin 2 | 13.0 | weight parts |
| Infrared absorption dye (Dye 1) | 6.0 | weight parts |
| Visualizing agent; Victria Pure Blue-BOH (manufactured | 2.8 | weight parts |
| by Hodogaya Chemical Co., Ltd.) | | |
| Fuluorine type surfactant; Megafac F-178K (manufactured | 1.0 | weight parts |
| by Dainippon Ink & Chemicals Inc.) | | |
| Solvent; methyl ethyl ketone/1-methoxy-2-propanol (1/2) | 903.0 | weight parts |

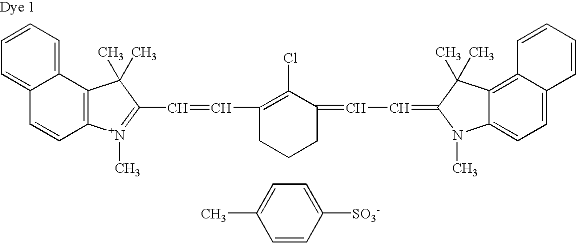

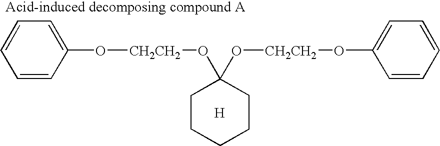

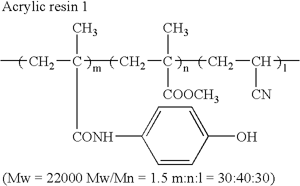

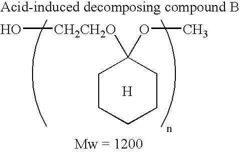

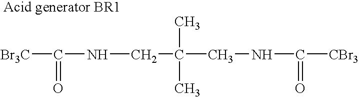

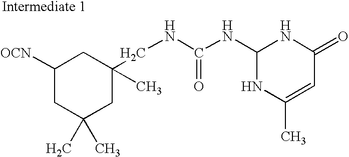

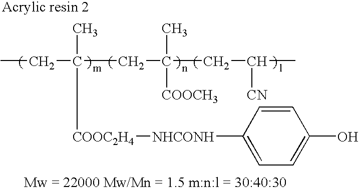

<Preparation of Planographic Printing Plate Material Samples 2 and 3>

Further, planographic printing plate material samples 2 and 3 were prepared in a similar manner to planographic printing plate material sample 1, except that an acid-decomposing compound and a visualizing agent in the under layer coating solution and a visualizing agent in the upper layer coating solution were changed as described in table 1.

<Evaluation Method>

(Exposure and Development)

With respect to planographic printing plate material samples, a screen image exposure corresponding to 175 lines was performed at 2,400 dpi (dpi is the number of dots per inch or 2.45 cm) by use of PTR-4300, manufactured by Dainippon Screen Mfg. Co., Ltd., at a drum rotation rate of 1,000 rpm, under varying laser power of 30-100%.

The plate sample, after exposure, was developed by utilizing an automatic processor “Raptor 85 Thermal”, manufactured by Glunz & Jensn A/S, and a developer solution “PD-1” produced by Kodak Polychrome Graphics, at 30° C. for 15 seconds.

<Evaluation>

(Sensitivity)

After a 100% solid image exposure under varying laser exposure energy, the density at each energy value of the developed image was measured using a densitometer D196, manufactured by Gretag Macbeth A G. The amount of energy to obtain a density, after development, of “a support density in the non-coated portion+0.01” was defined as the targeted sensitivity.

(Resistance against Developer Solution (Resistance against Film Thickness Loss))

Developer solution resistance (resistance against film thickness loss) in the image portion, after development, was evaluated based on the residual film ratios before and after development.

Residual film ratio (%)=(reflection density of the image portion after development−reflection density of support surface)/(reflection density of the image portion before development−reflection density of support surface)×100

The larger the number, the smaller the film thickness loss, which means that resistance against film thickness loss is excellent.

(Residual Tint)

The non-image portion after development was visually observed to evaluate residual tint based on the following criteria:

A: No bluish tint is observed.

B: Between A and C.

C: Significant bluish tint is observed.

[(Aging Stability (Sensitivity Variation Resistance)]

Planographic printing plate material samples were stored under at 23° C. and 60% RH for 6 months to evaluate variation value in sensitivity, whereby aging stability was determined.

Variation value in sensitivity=(sensitivity in the case of development after 6 months storage under at 23° C. and 60% RH)−(sensitivity upon immediate development)

A smaller value means excellent aging stability (sensitivity variation resistance).

The results are shown in Table 1.

TABLE 1

| | | | | | Evaluation results | | | |
|---|---|---|---|---|---|---|---|---|
| | | | | | | Resistance | | |
| Planographic printing plate material | | | | | | against film | | Aging |
| | Under layer | | | Upper | | thickness | | stability |
| | | Acid | | layer | | loss:Residual | | (variation |
| | | generating | Visualizing | Visualizing | Sensitivity | film ratio | Residual | value of |
| Sample No. | ** | agent | agent | agent | (mJ/cm²) | (%) | tint | sensitivity) |
| 1 | ** A | BR1 | none | present | 80 | 98 | A | ±0 mJ |
| (Invention) | ** B | | | | | | | |
| 2 | ** A | BR1 | present | none | 80 | 98 | C | ±50 mJ |
| (Comparison) | ** B | | | | | | | |
| 3 | none | BR1 | none | present | 120 | 90 | A | ±0 mJ |
| (Comparison) | none | | | | | | | |

** Acid-decomposing compound

It is clear from Table 1 that a planographic printing plate material, being capable of infrared laser exposure, of this invention has been enhanced to exhibit superior sensitivity and better developer solution resistance [resistance against film thickness loss [a residual film ratio (%)]], as well as excellent aging stability (resistance against sensitivity variation), and no generation of residual tint.

What is claimed is:

1. A planographic printing plate material comprising an under layer and an upper layer, each of which contains an alkali-soluble resin, accumulated on a hydrophilic support,
wherein a visualizing agent is incorporated in the upper layer and an acid-decomposing compound and an acid generating agent are incorporated in the under layer.

2. The planographic printing plate material described in claim 1,
wherein the acid-decomposing compound is a compound represented by following Formula (1) or (2): 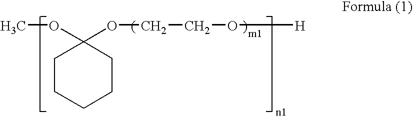
wherein, m1is an integer of 1-4 and n1 is an integer of 2-30, 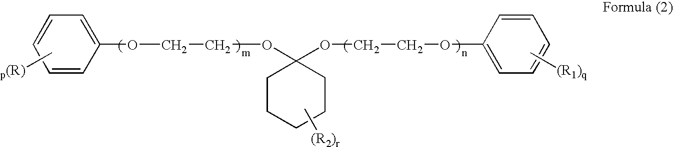
wherein, R, R₁ and R₂ are each a hydrogen atom, an alkyl group having a carbon number of 1-5, an alkoxy group having a carbon number of 1-5, a sulfo group, a carboxyl group or a hydroxyl group; p, q, and r are each an integer of 1-3; and m and n are each an integer of 1-5.

3. The planographic printing plate material described in claim 1,
wherein the visualizing agent is a quaternary nitrogen containing compound.

4. The planographic printing plate material described in claim 1,
wherein the hydrophilic support is aluminum which has been subjected to a hydrophilicity treatment by polyvinylsulfonic acid.
